(19) United States
(12) Patent Application Publication
(10) Pub. No.: US 2015/0308864 A1
(43) Pub. Date: Oct. 29, 2015

(54) Vector Sensor for Seismic Application

(71) Applicants: Björn N. Paulsson, Woodland Hills, CA (US); Jules L. Toko, Los Angeles, CA (US); Frank Slopko, Victorville, CA (US); Jon A. Thornburg, Woodland Hills, CA (US); Ruiqing He, Northridge, CA (US)

(72) Inventors: Björn N. Paulsson, Woodland Hills, CA (US); Jules L. Toko, Los Angeles, CA (US); Frank Slopko, Victorville, CA (US); Jon A. Thornburg, Woodland Hills, CA (US); Ruiqing He, Northridge, CA (US)

(73) Assignee: Björn N. P. Paulsson

(21) Appl. No.: 14/120,093

(22) Filed: Apr. 24, 2014

(51) Int. Cl. G01D 5/353; G01H 9/00; G01V 1/48

(52) U.S. Cl. CPC G01D 5/353; G01V 1/48; G01H 9/004; G01V 2210/1234

(57) ABSTRACT

A vector sensor system includes an optical fiber and a sensor array having a plurality of sensor levels and a plurality of optical fiber vector sensors, each sensor level having at least one of the optical fiber vector sensors. The sensor system further includes circuitry configured to provide optical input signals into the optical fiber and to receive optical output signals from the optical fiber. Each optical fiber vector sensor includes a vector mandrel and a first length of the optical fiber wound around the mandrel. The sensor levels are connected to one another by a second length of the optical fiber. Circuitry is configured to extract from the optical return signals backscattered light information from the first lengths of the optical fiber and to determine phase change information between the optical input signals and the optical output signals based on the backscattered light information.

### BACKGROUND

In the fields of geophysical exploration and geophysical investigation it is known to use arrays of sensors in order to collect seismic data in a three dimensional domain. The sensor arrays typically include a plurality of three-component (or 3C) sensor pods, with each sensor pod including three separate seismic sensors arranged and configured to detect seismic signals in three different orthogonal directions. The seismic sensors typically are geophones, accelerometers or hydrophones. The hydrophones are used in the marine environment. In the field of geophysical exploration the sensor arrays are typically placed on land, or are a towed array in a marine environment. In the field of geophysical development and production the sensor arrays are commonly placed within a borehole. Borehole seismology (i.e., placing a 3C sensor array within a borehole) is a common tool for determining advanced information with respect to a subterranean formation that is being further investigated for the presence of desirable fluids (e.g. gas, oil and or water), as well as for determining information with respect to a subterranean formation from which fluids are currently being extracted. One exemplary application of borehole seismology is for monitoring a subterranean reservoir over time for changes due to fluid extraction and/or fluid injection (such as in secondary and tertiary recovery). In this instance, the properties of the reservoir can change over time, thus altering the compression wave (or “P wave”) and shear wave (or “S wave”) velocities and attenuation at which sound moves through the reservoir in different directions. Specific (and non-limiting) examples where borehole seismology is particularly useful is in monitoring geothermal wells and carbon storage in subterranean reservoirs.

Borehole seismic data is superior to surface seismic data for high resolution imaging and monitoring for a number of reasons. First, sensors placed within a borehole are closer to the imaging target (i.e., features within the subterranean formation), and the sensors can be clamped into a consolidated formation allowing for the recording of higher frequency higher fidelity raw data. Second, the sensors are away from the noisy surface environment, thus providing higher signal to noise ratio data. Third, converted shear (CS) wave data can be recorded because the sensors are avoiding the near surface layer with its low shear modulus and high attenuation of the shear waves. Fourth, the downgoing wave fields closely sampled allow a highly accurate velocity model to be built free from near-well anomalies experienced by well logs and the inaccuracies inherent in surface seismic velocity models. The downgoing wave fields also allow accurate estimation of deconvolution functions as well as anisotropic parameters for 3D processing and imaging using recorded data. Finally, sensors within a wellbore are placed in depth such that more sophisticated depth imaging approaches will result from natural and more accurate imaging techniques. These depth imaging techniques include Kirchhoff prestack depth migration, interferometric migration, wave equation migration and reverse time migration.

As one example, water injected into a geothermal reservoir changes the state of the stress in the subterranean formation (which encompasses the geothermal reservoir) since the water will be injected at a pressure above the ambient pore pressure lowering the effective stress of the formation. A decrease in the effective stress tends to decrease the compression (“P”) and shear (“S”) wave velocities and increase the attenuation of P and S waves. However, water injected in dry fractures and dry fracture zones dramatically changes both the velocity and the attenuation of both P and S waves. That is, the velocities increase because the bulk modulus increases, but the attenuations increase in some cases by filling the fractures and fracture networks in such a manner that the fractures and fracture networks open while using water rather than being filled with air and being closed as in dry reservoir rock. This decoupling of the effects of the velocities and attenuation can be used to further improve an understanding of the dynamics of a geothermal reservoir. However, such a detailed study and improved understanding is dependent on being able to obtain high quality data properly sampled both spatially and temporally. A high resolution borehole seismic technique (such as provided by the disclosure below) allows for monitoring the changes in the state of a reservoir using active seismic sources. Another approach to obtaining detailed information regarding the dynamics of a geothermal reservoir is to use micro seismic events (i.e., naturally occurring or induced micro-earthquakes) or passive seismic monitoring to characterize the dynamics of the geothermal reservoir. The injection of water into a reservoir will naturally generate micro seismic events due to both the increase in the pore pressure as well as the cooling of the reservoir rock by the injected water. If high quality active and passive source P and S wave data can be recorded with an ultra long (e.g., at least 3-5 km long) borehole seismic system equipped with sensitive accelerometers (or other sensors), one would be able to produce quantitative 3D volumetric maps of reservoir architecture and the properties of the reservoir rocks, as well as the rock formation around the reservoir. Further, by using a highly repeatable borehole seismic method using either active or passive sources, or preferably a combination of both sources, one would be able to track fluid flow as well as pressure changes in the rock (i.e., the local subterranean formation) since P and S wave velocities and attention are sensitive to different properties of the reservoir and generate complimentary images. In order to map natural fractures and faults, which can greatly affect the operation and the economy of a geothermal reservoir, polarized shear wave data is also preferably collected and processed. This type of data can essentially only be effectively be collected in boreholes by using long seismic arrays (e.g., 3000-5000 meters or more) recording high fidelity multi-component data. Further, the surface at an industrial scale geothermal site is typically too noisy to allow recording of high quality, high frequency, surface seismic data. Thus, a borehole receiver array deployed below the surface layer, and the resulting data, will be less affected by surface noise. Another application for borehole seismology is to image oil fields located in urban areas, e.g. under Los Angeles, Calif. where the third largest oil field accumulation in the U.S. resides, with an estimated 10-20 billion barrels of oil in place (as per USGS). This oil field cannot be imaged using surface seismology because of the high noise level, the complex reservoirs and the surface access due to the urban environment. In order to image oil and gas fields in an urban environment one typically has to use ultra-long borehole seismic arrays deployed into existing vertical and deviated oil and gas wells.

FIG. 1 is a schematic diagram depicting in side view one example of borehole seismology in a subterranean formation 10. In FIG. 1 a borehole 12 is formed in the formation 10 below the surface 11. The borehole 12 depicted in FIG. 1 is a deviated borehole, in that it contains a lower section 17 which deviates horizontally from a generally vertical upper section 19. The formation 10 depicted in FIG. 1 is shown as having an interface 13 between different layers of materials (e.g., such as a sandstone-granite interface), as well as a fault 15. In one example, it is desirable to determine the locations and orientations of the interface 13 and the fault 15. This can be done using borehole seismology, provided that the appropriate sensors are used. As an example, assume that a seismic source 18 (i.e., a source of seismic energy which can propagate through the formation 10) is provided at the surface 11. Further assume that a first three component sensor 14 is placed in the upper portion 19 of the borehole 12, and a second three component sensor 16 is placed in the lower, deviated section 17 of the borehole 12. The seismic source 18 will generate seismic energy which propagates radially in all directions within the formation 10. As a general rule of physics, and absent any effects such as diffraction, the seismic energy will reflect off of the interface 13, and the fault 15, and be received by the 3C sensors 14 and 16. For example, a first signal S1 will reflect off of the interface 13, and reflection signal S1′ will be received at 3C sensor 14. Likewise, second signal S2 will reflect off of the interface 13, and reflection signal S2′ will be received at 3C sensor 16. Further, third signal S3 will reflect off of the fault 15, and reflection signal S3′ will be received at 3C sensor 16. (Other reflections can be received by the 3C sensors 14 and 16, but are not shown for sake of simplifying the diagram.) As indicated at the 3C sensor locations 14 and 16, each three-component (3C) sensor assembly records data in three orthogonal directions as follows: an axial direction “A” oriented along the axis of the borehole 12; a first radial direction R₁ which is orthogonal to the axial direction in a first dimension; and a second radial direction R₂ which is orthogonal to the axial direction in a second first dimension, as well as orthogonal to the first radial direction R₁. As can be appreciated from FIG. 1, the orientation of the three component directions (A, R₁, R₂) can change with respect to the surface 11 if the borehole 12 is deviated. Thus, rather than use the classic coordinated of x, y and z for spatial orientation (which are generally understood as being fixed with respect to the surface 11), the coordinate system of A, R₁, R₂ is fixed according to the axis of the borehole 12.

With further respect to FIG. 1, it is a primary objective of borehole seismology to be able to determine the angles between the borehole 12 and the reflection of the signals off of interfaces (13) and faults (15) within the formation 10. It is also desirable to know the amplitude of the signals arriving at the 3C sensor assemblies (14, 16), and the arrival time of the signals at the sensors. Thus, for FIG. 1, it is desirable to know the angle θ₂ between the reflection signal S1′ and the borehole 12, the angle θ₁ between the reflection signal S2′ and the borehole, and the angle θ₃ between the reflection signal S3′ and the borehole. Unfortunately, geophone based borehole sensor arrays provide relatively poor discernment of the individual orthogonal signal components A, R₁, R₂, thus making it difficult to determine the reflection signal angles. Further, geophone based borehole sensor arrays provide relatively poor amplitude sensitivity.

Borehole seismology presents two special circumstances which differentiate this field of seismic investigation from typical land and marine seismic surveys. First of all, the environment within a borehole can be substantially different than the environment to which seismic sensors are exposed to in land and marine surveys. Specifically, a borehole environment can expose seismic sensors to high temperatures and high pressures which are not typically encountered in land and marine seismic surveys. Thus, geophones (which can typically operate at temperatures up of about 150° C.) can fail in borehole environments above this temperature. Secondly, while land and marine seismic surveys are often performed on a large scale basis (and thus a relatively low data sampling rate is acceptable), in borehole seismology it is much more common to look for seismic data on a finer scale, and thus a higher data sampling rate is desired. More specifically, with respect to temperature limitations, geophones are typically limited to an operating temperature of about 150° C. or less, which renders them of little or no value for borehole environments above this temperature. Further, with respect to data sampling rates, geophones are typically limited to an operational frequency of about 200 Hz (which effectively requires 500 samples per second which is commonly referred to as a 2 millisecond sampling rate), and are thus limited to detecting differences in distance between reflections (based on recorded seismic signals) of about ¼ of a wavelength or about 6.25 meters. (This is based on a common speed of sound in rock formations of 5 km/sec, or 5000 m/sec. For a useful frequency of 200 Hz this translates to a wavelength of 25 m and it is commonly agreed that geophones can only resolve ¼ of a wavelength, or about 6.25 m.) For the purposes of borehole seismology it is typically desirable that a resolution of less than 6.25 meters be provided by the seismic sensors. As one example, one will routinely record micro seismic data with a frequency of 500 Hz during monitoring of natural or induced fracturing within a subterranean formation. To properly sample 500 Hz data in a 3,000 m/sec material, generating wavelengths as short as 6 meters, one has to sample the data twice per the shortest wavelength, or about every 3 meters. In order to do so and have a long array, i.e. a large aperture antenna, one has to be able to deploy hundreds of 3C sensors.

Traditional borehole seismology is accomplished using a wireline-based system sensor array which incorporates a plurality of geophones. The geophones can be grouped at levels, which can be spatially separated from one another. For a three-component sensor array (i.e., an array having the capability of distinguishing input signals in each of the X, Y and X axes), this requires providing three geophone point sensors at each level (i.e., three point sensors grouped within general proximity to one another at a given level). Thus, for each level, three geophones are required in order to acquire the desired three dimensional data associated with that level. However, each geophone requires an electrical power supply and digital electronics in order to render the geophone effective as a sensor. This necessitates a relatively thick wireline (typically 15/32 inch) to supply power to, and relay signals from, the geophone sensors. For a 15/32 inch wireline, the effective load is limited to about 8000 lb, thus limiting the number of sensors that can be deployed on the wireline to about 100 3C levels, which in turn limits the spacing between the levels and/or the total length of the array. Consequently, wireline based geophone arrays are unable to acquire the quality and quantity of data desired for a borehole survey of a subterranean formation. In addition, wireline based geophone arrays are costly to manufacture, costly to deploy (oftentimes requiring a tractor to pull the array into the borehole, particularly if the borehole is deviated), and limited to operational temperatures of less than about 150° C.

One prior art solution to address the two primary considerations described above (i.e., temperature tolerance of the sensor array, and providing a higher sampling rate) has been to use a fiber optic cable employing fiber Bragg gratings (FBGs) as the sensors. (See, for example, High-Resolution Distributed Fiber Optic Sensing, 2004 Naval Research Laboratory (NRL) Review, Optical Sciences, by C. K. Kirkendall et al., Sep. 19, 2005.) A fiber optic cable using fiber Bragg gratings can operate at temperatures up to 300° C., and can provide data at a rate of 1,000 MHz. However, fiber Bragg gratings are very fragile (and thus prone to failure when being placed in service). Perhaps more significantly, the cost of providing a fiber optic cable using fiber Bragg gratings is quite high, thus providing a significant impediment for the use of such FBG sensor arrays on a wide scale commercial basis. More importantly, the most FBG sensors that can be deployed on a single optical fiber is between about 30 and 100 sensors.

What is needed is a sensor, and a sensor array, which can operate in a severe environment (such as a within a borehole having temperatures of 200° C. or more), and which can provide high resolution data with a high signal to noise ratio, and which can be provided at a low cost as compared to alternative sensors, and particularly such a sensor array which can provide three component data.

### BRIEF DESCRIPTION OF THE DRAWINGS

FIG. 1 is a schematic diagram depicting in side view one example of borehole seismology in a subterranean formation.

FIG. 2 is an environmental diagram depicting in side view a Rayleigh vector sensor array according to the current disclosure within a borehole formed in a subterranean formation.

FIG. 3 is a side view of a Rayleigh vector sensor level of FIG. 2.

FIG. 4 is a side sectional view of a sensor pod containing three Rayleigh vector sensors according to the current disclosure.

FIG. 5 is an isometric view of an exemplary mandrel which can be used for a Rayleigh vector optical sensor according to the current disclosure.

FIG. 6 is a plan view of a general arrangement for a mandrel spring system which can be used for the mandrel of FIG. 5.

FIG. 6A is an isometric view of another mandrel which can be used for a Rayleigh vector optical sensor according to the current disclosure.

FIG. 6B is an end view of the mandrel depicted in FIG. 6A.

FIG. 6C is a side view of the mandrel depicted in FIGS. 6A and 6B.

FIG. 6D is a cross section view of the mandrel depicted in FIG. 6B.

FIG. 7 is a side view depicting an assembled Rayleigh vector sensor according to the current disclosure.

FIG. 8 is a side view of the mandrel of FIG. 5, and including a mandrel preload compression apparatus.

FIG. 9 is a schematic diagram of a Rayleigh vector sensor fiber optic geophone system in accordance with the present disclosure.

FIG. 10 is a flowchart depicting exemplary steps that can be performed in order to obtain an image using the Rayleigh vector sensor system disclosed and described herein.

FIG. 11 is a schematic diagram depicting a system and a process for determining phase from a Rayleigh scattered signal in accordance with the present disclosure.

FIG. 12 is a diagram depicting examples of high and low visibility signals and resulting demodulation signals for a Rayleigh scattered signal in accordance with the present disclosure.

FIG. 13 is an illustration of a healthy Rayleigh scattering signal and a faded Rayleigh scattering signal for Rayleigh scattered light signals in accordance with the present disclosure.

FIG. 14 is a graph showing the amplitude response, as a function of input frequencies, of a fiber optic seismic sensor according the current disclosure as compared to other sensors.

FIG. 15 is collection of three different graphs for three different kinds of sensors, including an optical fiber sensor according the current disclosure, showing the amplitude response of each sensor as a function of time. The top graph depicts the response of a state of the art accelerometer, the center graph depicts the response of an industry standard 15 Hz high temperature sensor and the bottom graph depicts the response of the fiber optic seismic sensor described herein below.

FIG. 16 is a diagram showing the amplitude response from tap tests of an optical fiber sensor according the current disclosure as a function of time and at various operating temperatures.

### DETAILED DESCRIPTION

We have developed a sensor, a sensor array, a sensor system, and accompanying methods which are particularly useful for performing borehole seismology, which provide high quality data, which can operate in hostile environments, and which can be provided at a low cost as compared to prior art borehole sensor methodologies. The sensor array disclosed and described herein includes a plurality of point sensors located at a plurality of spaced-apart levels, with one or more (and preferably three) of the point sensors located at each level. The point sensors each include an optical fiber wound about a mandrel. Seismic data is recorded based on detecting changes in the Rayleigh backscattering from each of the point sensors. Rayleigh backscattering is a natural phenomenon which occurs when light energy propagates through an optical fiber and results primarily from impurities and dopants in the optical fiber. The naturally occurring Rayleigh backscattering in an optical fiber is essentially constant and can be measured for a given light source (frequency and amplitude) provided to the optical fiber, but changes when the optical fiber is subjected to changes in strain. Previously Rayleigh backscattering due to changes in strain of an optical fiber has not been used for point sensor application since the changes are small and have been difficult to detect with the degree of precision required for point sensors. However, we have developed a point sensor (optical fiber sensor) which amplifies the Rayleigh backscattering effect at the point sensor, thus rendering the sensor useful for application in borehole seismology and the like. The sensor array disclosed and described herein can include a single optical fiber which is wound around a large number of mandrels to form point sensors, with the mandrels (and thus the sensors) grouped at levels, with the levels being spaced apart from one another, but in signal communication with one another via the optical fiber. We have also developed a system for interrogating the data from an optical fiber which includes the Rayleigh backscattering based point sensors. At each level in the sensor array three of the Rayleigh backscattering based point sensors can be oriented at three different orthogonal directions, thus allowing three dimensional vector information (i.e., direction and amplitude in each of the three orthogonal directions) to be obtained for each level. Accordingly, in the following discussion, we will refer to a Rayleigh backscattering based point sensor as a Rayleigh vector sensor, or by the acronym “RVS”, or alternately as an optical fiber sensor. We will also refer to the sensor array which includes the Rayleigh vector sensors as a Rayleigh vector sensor array, or an optical fiber sensor array, and we will refer to a system which includes the Rayleigh vector sensor array and the components for interrogating the data from the array as a Rayleigh vector sensor system (or by the acronym “RVSS”), or as an optical fiber sensor system.

The measurement of changes in Rayleigh backscattering in optical fibers has been used in the past to detect bulk changes along the length of the fiber (e.g., changes in temperature), but has not heretofore been used for point sensor application. The optical fiber sensor array described and disclosed herein can thus not only use the Rayleigh backscattering data obtained from the point sensors we have developed, but can also use the distributed Rayleigh backscattering data from the distributed optical fiber between the sensor levels. More specifically, the Rayleigh backscattering data from the optical fiber located between the sensor levels can be used to determine the first arrival time of seismic signals between sensor levels, and thus to assist in determining velocity information of the formation.

The Rayleigh vector sensor system disclosed herein includes at least the following three basic integrated components: the Rayleigh vector sensor (described below); a telemetry cable (including an optical fiber); and an optical interrogator (also described below). The Rayleigh vector sensor system is particularly useful in borehole seismology applications, but is not limited to this application. For example, the Rayleigh vector sensor system can be used for traditional seismic surveys (e.g., surface and towed arrays), as well as in long-term placed arrays (e.g.: placement on the ocean floor to monitor for submarine activity and the like; and placement on a ground surface for earthquake monitoring and the like).

A large number of fiber-optic channels can be deployed on each optical fiber, making a large channel count system possible in hostile environments such as in boreholes and on ocean floors. The Rayleigh vector sensor requires only a single optical fiber, making the Rayleigh vector sensor array and system robust with a potentially long survival time. Specifically, no electric power needs to be transmitted to the optical fiber based Rayleigh vector sensor, nor does the optical fiber, or the optical fiber based vector sensor, generate any electric signal, making the Rayleigh vector sensor array intrinsically safe and immune from electromagnetic and radio frequency interference.

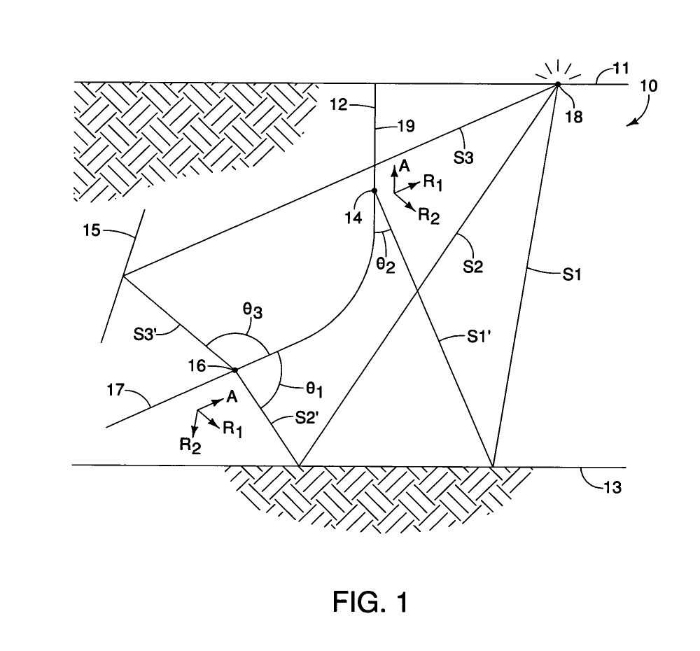

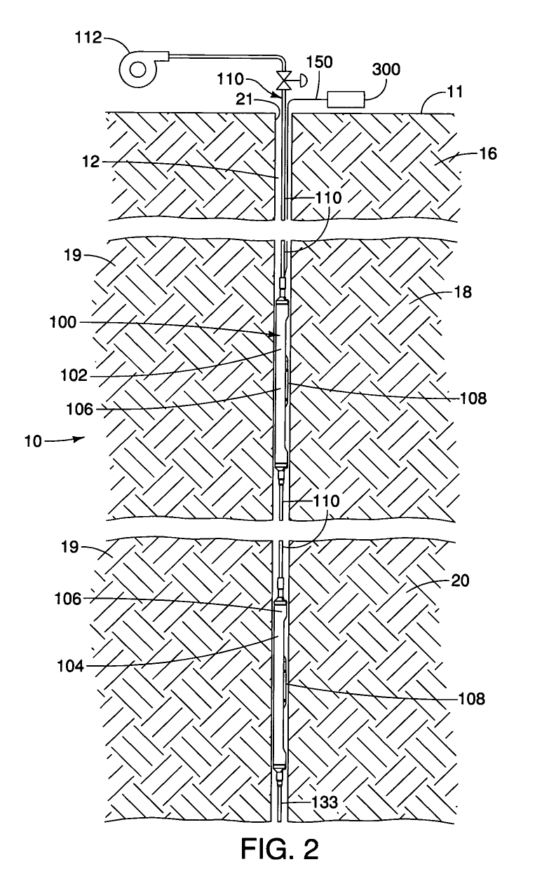

Turning now to FIG. 2, an environmental diagram is provided depicting in side view a Rayleigh vector sensor array 100 (or optical fiber sensor array) within a borehole 12 formed in a subterranean formation 10. The portion of the formation 10 depicted in FIG. 2 can correspond generally to the upper portion of the formation 10 depicted in FIG. 1. The sensor array 100 of FIG. 2 is shown with two levels of three-component (3C) Rayleigh vector sensors (which are not shown in FIG. 2) as follows: a first level 102 and a second level 104. Many more levels can be added to the RVS array 100, but are not shown in FIG. 2 for the sake of simplicity. Each 3C sensor level 102, 104 is provided with a separate sensor pod housing 106, and each sensor pod housing supports a sensor pod 108. The sensor pods 108 can each support three Rayleigh vector sensors (not shown in FIG. 2). (A sensor level 102, 104 can support less than three Rayleigh vector sensors, or more than three such sensors, but for standard three dimensional seismic imaging three Rayleigh vector sensors are used at each level.) Each sensor pod housing 106 can include a sensor pod deployment system (not shown in FIG. 2) for deploying the sensor pods 108 into contact with the borehole wall 21. In the example depicted in FIG. 2 the sensor pods are intended to be deployed by a hydraulic actuated deployment system, which is actuated by hydraulic fluid from pump 112 and hydraulic lines 110. The advantages of using a hydraulic deployment system are as follows: the hydraulic line 110 can be used to support the sensor pod housings 106 within the borehole 12; the use of hydraulics means that electrical power cables do not need to be incorporated into the sensor array 100; and hydraulic actuators can provide high clamping forces to clamp the sensor pods 108 to the borehole wall 21, thus improving signal reception by the individual Rayleigh vector sensors. FIG. 2 also depicts the optical fiber 150 from the sensor array 100 connected to the light generation and signal processing system 300 (described more fully below).

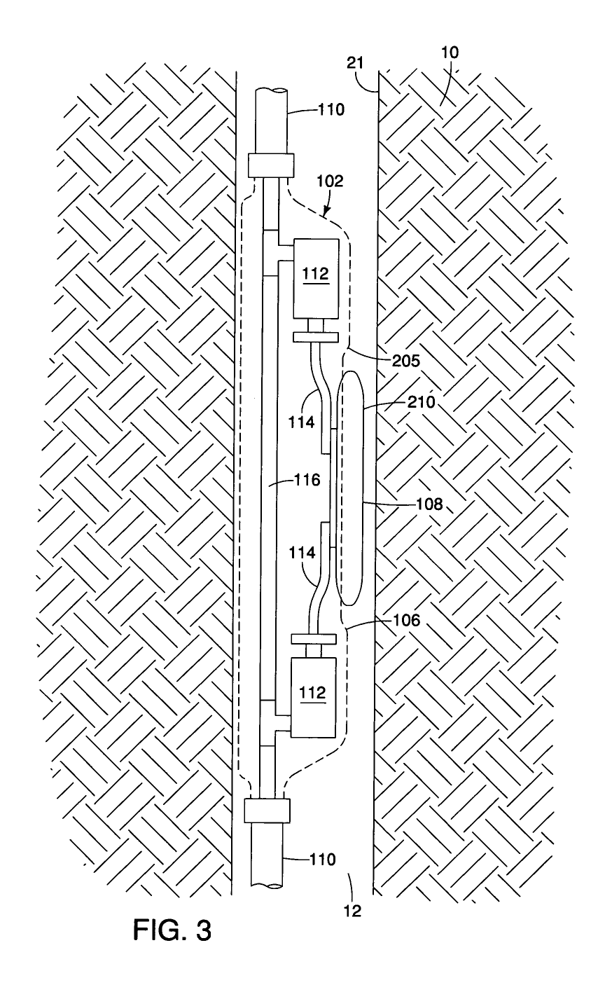

FIG. 3 is a side view of the Rayleigh vector sensor level 102 of FIG. 2. The sensor level 102 includes the sensor pod housing 106 (shown in phantom lines) and the sensor pod 108 (which houses the Rayleigh vector sensors, not shown in FIG. 3). The sensor level 102 can be connected to other sensor levels by hydraulic tubing 110. The sensor level 102 also includes one or more hydraulic actuators 112 which can be used to move one or more mechanical elements 114 to thereby move the sensor pod 108 out of the housing 106 and into contact with the borehole wall 21. Contact with the borehole wall is known as clamping, and thus the hydraulic actuators 112 can be part of an overall clamping system used to secure the sensor pod 108 into contact with the borehole wall 21. Preferably each sensor housing 106 is provided with a built-in clamping system, as exemplarily shown by the hydraulic actuators 112 in FIG. 3. The sensor level 102 also includes an exemplary hydraulic fluid conduit 116 which allows hydraulic fluid to be communicated between the various sensor levels in the sensor array 100.

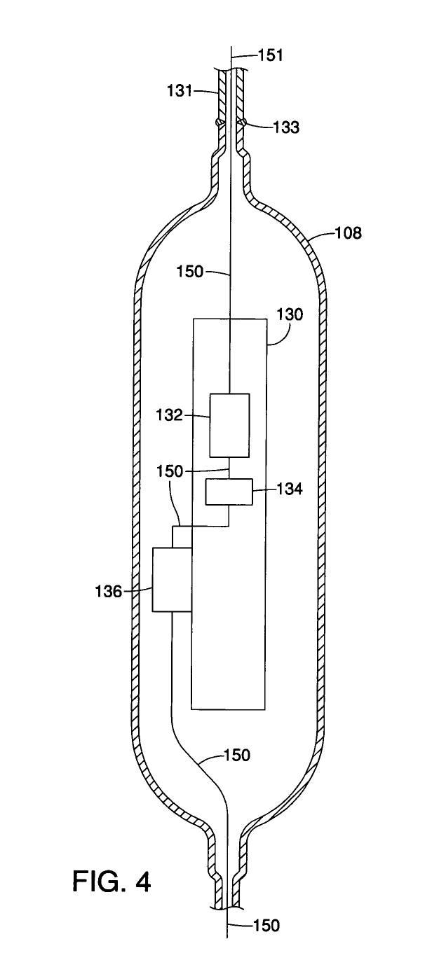

FIG. 4 is a side sectional view of a sensor pod 108 (of FIGS. 2 and 3). The sensor pod 108 can include a sensor support 130 which is rigidly mounted to the sensor pod. The sensor support 130 can support three Rayleigh vector sensors 132, 134 and 136, which can be mounted orthogonal to one another (to thus form the three dimensional triad of A, R₁, R₂ described above with respect to FIG. 1). A continuous optical fiber 150 can join the Rayleigh vector sensors 132, 134 and 136 in serial arrangement, and can also allow additional sensor pods 108 to be connected in series (as indicated in FIG. 2).

The Rayleigh Vector Sensor

As described above, the fiber optic based Rayleigh vector sensor (or optical fiber sensor) is essentially immune to electric and electromagnetic interference since the Rayleigh vector sensor system does not require any electronics at the Rayleigh vector sensors in the borehole. This design also makes the Rayleigh vector sensors extremely robust and able to operate in extreme environments such as temperatures up to 300° C. using a standard commercially available polyimide coated optical fiber. Even higher operational temperatures can be obtained using specialty fibers such as metal (e.g., gold) coated fibers. The Rayleigh vector sensor includes a plurality of windings of an optical fiber about a mandrel. This turns the optical fiber windings at each mandrel into essentially a point sensor. The Rayleigh vector sensor thus includes two components: an optical fiber and a mandrel. We will now discuss each component.

Optical Fiber

The optical fiber (e.g., 150, FIG. 4) used for the Rayleigh vector sensor described herein preferably has a high Rayleigh scattering coefficient found in fibers with a high numerical aperture (NA) (e.g., about 0.24), a high non-linear threshold, and low attenuation (e.g., less than about 0.1 dB/km), which improves sensitivity. The selection of a specific fiber to be used for the Rayleigh vector sensor can be determined by testing different fibers, and then selecting the fiber that gives the best balance between a high Rayleigh backscattering effect, a high non-linear threshold response, and low attenuation. In general, as the numerical aperture is increased, the sooner non-linear effects will appear. (Non-linear effects result from the optical fiber approaching energy saturation limits, such that signal responses are not linear across a range of wavelengths. As can be appreciated, it is desirable to have a linear (or proportional) signal response across a range of wavelengths, since data that is non-linear cannot be processed using the same algorithms as are used to process linear data.) The optical fiber selection process can be performed by testing a variety of different available optical fibers. One such testing method can be performed by providing an Erbium-doped optical fiber amplifier (or EDFA), and providing different inputs (power and wavelength) into the optical fiber (preferably using an optical fiber of the length that is intended to be used in the sensor array), and measuring the outputs from the fiber. The most desirable fiber will be one that that provides the best Rayleigh backscattering effect within the range of intended power inputs (over the length of the fiber), while also having acceptable levels of non-linear outputs, and also having low attenuation (i.e., does not diminish the output signal over the length of the fiber). The selection of a particular desirable optical fiber to be used will also be affect by the anticipated thermal conditions to be encountered, as well as the overall length of the fiber to be employed. As can be appreciated, no one particular optical fiber will ideally fit all anticipated uses. It is therefore desirable to provide at least one sensor array having an optical fiber which accommodates a large number of intended uses, while also allowing for at least one custom-made sensor array which has an optical fiber which has been selected based on a specific intended use of the sensor array. Thus, the current disclosure allows for any number of different optical fibers to be used in the Rayleigh vector sensor array, based on: (i) the intended use; and (ii) the overall performance characteristics of the optical fiber (as discussed above). Fiber dopants, their concentrations, and preform design can affect all of the above parameters. Examples of dopants are Germanium and fluoride. The optical fiber preferably has a tensile strength of about 200 kpsi, a diameter of about 50-120 μm, and is polyamide coated. Examples of fiber manufacturers which currently produce acceptable fibers for use in the Rayleigh vector sensor are AFL (Duncan, S.C., U.S.), Fibercore (Southampton, U.K.), and Fibertronics Inc. (Hudiksvall, Sweden). All manufacture 80 um polyimide coated fibers with different performance specifications.

Mandrel for the Rayleigh Vector Sensor

The mandrel of the current disclosure is particularly useful as a component for a vector sensor since it is capable of imparting energy from a single direction into the optical fiber wound about the mandrel. (This feature is known as cross-axial isolation.) Thus, if the sensor (i.e., the mandrel and the optical fiber windings about the mandrel) is located within a formation in a particular known direction, then signals generated by the sensor will be representative of seismic energy received from essentially only a single direction. Thus, by grouping three such sensors at a common location, with each of the sensors mounted orthogonal to one another, three separate orthogonal signal components can be generated for that particular location (i.e., signals for each of the X, Y and Z axes of a three coordinate system). The signals generated by the sensors will thus include direction and amplitude information—i.e., vector data. By collecting this vector data over an array of such sensors, vector analysis can be performed on the overall data set, allowing the source (i.e., direct source or reflection source) of the seismic signals to be determined. This, coupled with the high sampling rate enabled by the use of the optical fiber, allows a very detailed three-dimensional image of the formation to be generated. The mandrel of the current disclosure is also particularly useful as a component for a sensor since it provides a high signal to noise ratio and a high degree of cross axis isolation which generates the desired data vector fidelity. The mandrel can thus be described as a vector mandrel, but may be referred to herein simply as a mandrel for the sake of simplicity of the description.

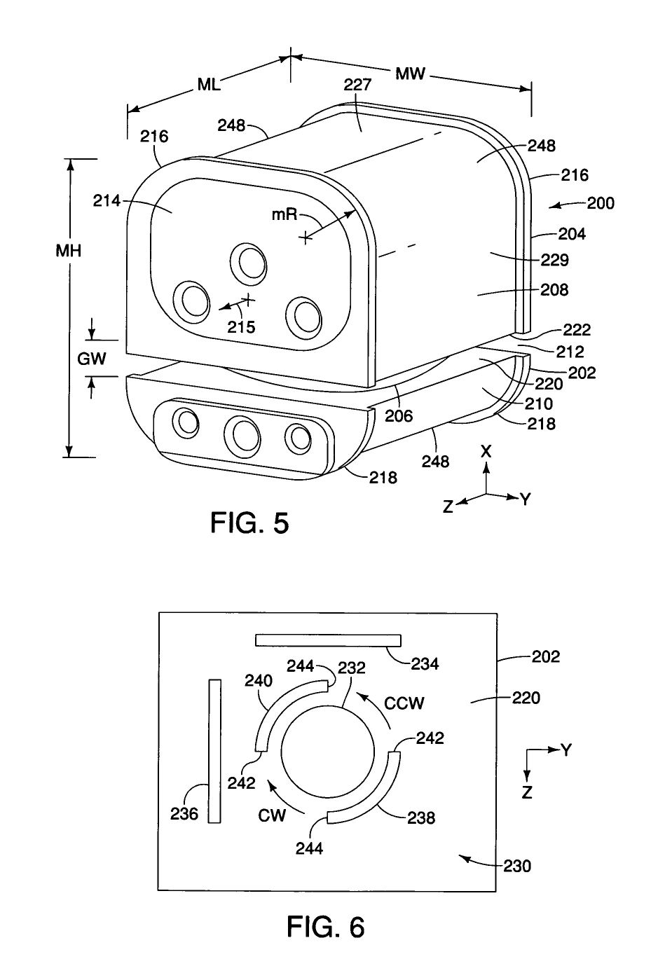

One exemplary vector mandrel 200 which can be used for a Rayleigh vector sensor (e.g., 132, FIG. 4) is depicted in FIG. 5 in an isometric view. The mandrel 200 is preferably a two-part mandrel having a first mandrel part 202 and a second mandrel part 204, the two mandrel parts (202, 204) being spaced apart from one another by a mandrel gap 212. The mandrel 200 includes a mandrel spring member 206 which is positioned in the mandrel gap 212 between the first and second mandrel parts (202, 204). The mandrel spring 206 is configured to provide cross-axial isolation of inputs (i.e., energy) to the mandrel 200 to thus constrain elongation (i.e., strain) of the mandrel due to energy input to a single direction. The first mandrel part 202 can be secured to a sensor pod (108, FIG. 4), and the second mandrel part 204 of the mandrel is preferably unmounted. The second mandrel part 204 can include a slug 214 of a heavy (i.e., dense) metal in order to increase the mass of the second mandrel part, thus forming two opposing significant masses (i.e., the first mandrel part 202 and the attached sensor pod and clamped formation, i.e. the Earth, and the second mandrel part 204) so that incoming energy (i.e., acceleration) has to move one large mass (the Earth) against another large mass (sensor reaction mass), and thus movement of the two masses, which are joined by a stiff spring element, with respect to one another is increased, with the result being that the incoming energy is dissipated by elongating (straining) windings of the optical fiber (not shown in FIG. 5) about the mandrel 200 by the relationship F=m*A where F=Force, m=sensor reaction mass and A is the acceleration of Earth. The Earth acceleration is thus imparting energy into the fiber which acts as a stiff spring by the inertia of the large mass comprising the reaction mass. (i.e., the second mandrel part 204).

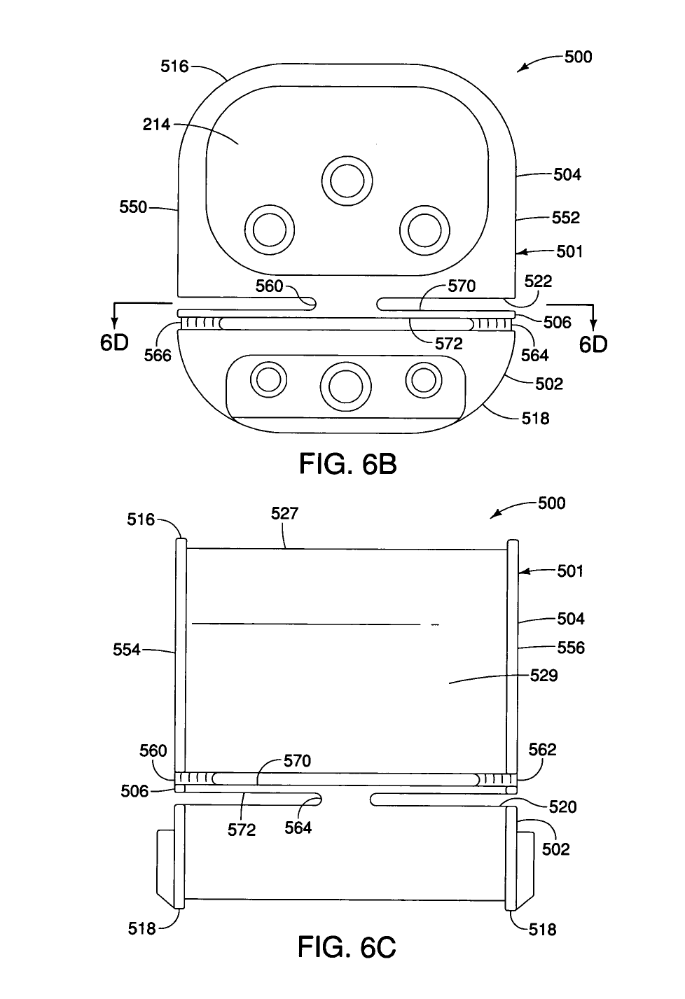

The mandrel first part 202 defines a first optical fiber support surface 210 which supports windings of the optical fiber (not shown in FIG. 5, but depicted as 150 in FIG. 7). Likewise, the mandrel second part 204 defines a second optical fiber support surface 208 which supports windings of the optical fiber. When the optical fiber is wound onto the fiber support surfaces 208 and 210 (as depicted in FIG. 7, described below), the optical fiber spans the mandrel gap 212. The mandrel first part 202 can include retaining flanges 218 to prevent windings of the optical fiber from slipping off of the fiber support surface 210. Likewise, the mandrel second part 204 can include retaining flanges 216 to prevent windings of the optical fiber from slipping off of the fiber support surface 208.

The mandrel first and second parts 202, 204 are preferably made from a relatively dense material, as for example stainless steel. As indicated above, the mandrel second part 204 can be provided with a slug 214 in order to increase the mass of the mandrel part 204. In one example the mandrel slug 214 is made from tungsten, which has a density of approximately 18.3 grams per cubic centimeter. Preferably the slug 214 has a density of between about 15 and 25 grams per cubic centimeter (as compared to a density of approximately 8 grams per cubic centimeter for the surrounding portion of the second mandrel part 204 when this part is fabricated from stainless steel). The slug 214 can be tightly fitted into the mandrel second part 204 so as to form a consolidated mass. One method for securing the slug 214 into the mandrel second part 204 is by a heat-assisted shrink fit (i.e., heating the mandrel second part 204 to allow the slug 214 to fit into the slug opening, and then allowing the mandrel second part 204 to cool and thus form a shrink fit around the slug). As indicated above, it is desirable that the mandrel second part 204 have sufficient mass to resist movement of the mandrel second part following Newton's first law of inertia. In one example the mandrel second part 204 (sans the slug 214) is fabricated from stainless steel, and has a mass of about 45 grams, while the mandrel slug 216 is fabricated from tungsten and has a mass of about 94 grams, providing a total mass for the mandrel second part of about 135 grams. This mass has been determined to provide adequate inertial resistance to acceleration by the Earth comprising incoming seismic signals (seismic energy) such that a large portion of the incoming seismic energy is imparted to the optical fiber windings by inertia of mandrel part 204 of the mandrel 200.

The mandrel spring 206 is preferably configured to allow movement between the mandrel first and second parts (202, 204) in an “X” direction which is perpendicular to the mandrel gap 212, while reducing movement of the mandrel first and second parts in directions “Y” and “Z” which are parallel to the mandrel gap. The mandrel spring 206 is also preferably configured such that the spring does not move against the opposing surfaces (220, 222) of the first and second mandrel parts (202, 204) during flexing of the spring. That is, movement of the mandrel spring 206, or components thereof, along the surfaces 220, 222 of the first and second mandrel parts (202, 204) in the “Y” and “Z” directions can impart noise (due to frictional resistance) to the mandrel parts, which can then be imparted to the optical fiber windings, thus decreasing the signal to noise ratio of the optical fiber sensor. Further, the mandrel spring 206 is preferably contained within the mandrel gap 212 such that no part of the mandrel spring 206 extends beyond the mandrel surfaces 220, 222, thus ensuring that the optical fiber windings (see FIG. 7) are not in direct contact with any portion of the mandrel spring 206. The mandrel spring 206 can include a mandrel spring system having two or more components, including one or more spring components and one or more movement restriction components (to thus assist in restricting movement of the first and second mandrel parts 202, 204 in directions “Y” and “Z”). In one example the mandrel spring 206 is a mandrel spring system having two bow springs mounted at about 90 degrees with respect to one another. The first bow spring can be secured to the first mandrel part 202 by welding the ends of the first bow spring to the underside surface 220 of the first mandrel part 202 (i.e., the surface of the first mandrel part which is parallel to, and juxtaposed to, the opposing surface 222 of the second mandrel part 204), while the second bow spring can be secured to the second mandrel part 204 by welding the ends of the second bow spring to the underside 222 of the second mandrel part 204. In this way the two bow springs act not only as spring components in direction “X” between the first and second mandrel parts 202, 204, but also operate as motion restrictors (in directions “Y” and “Z”) between the two mandrel parts. In another example the mandrel spring 206 can include a mandrel spring system having a bellows spring placed between the first and second mandrel parts 202, 204, and orthogonally oriented motion isolators connecting the first and second mandrel parts. In this example each motion isolator can be a strip of spring steel having a first end secured (by welding or the like) to the underside 220 of the first mandrel part 202, and a second end secured (by welding or the like) to the underside 222 of the second mandrel part 204. In a further example the mandrel spring 206 can include a mandrel spring system having a first Bellville spring secured (by welding or the like) to the underside 220 of the first mandrel part 202, and a second Bellville spring secured (by welding or the like) to the underside of the second mandrel part 202. In this arrangement, preferably the narrow diameter end of the Bellville springs are secured to the opposing faces (surfaces 220 and 222) of the respective first and second mandrel parts 202, 204. The two Bellville springs can meet at a common junction (preferably, at the wide diameter end of the Bellville springs), and a low friction, high temperature-tolerant interface (such as a graphite bearing) can be provided between the mating surfaces of the two Bellville springs. Other arrangements for the mandrel spring 206 can include a compound cross-axial leaf spring configuration.

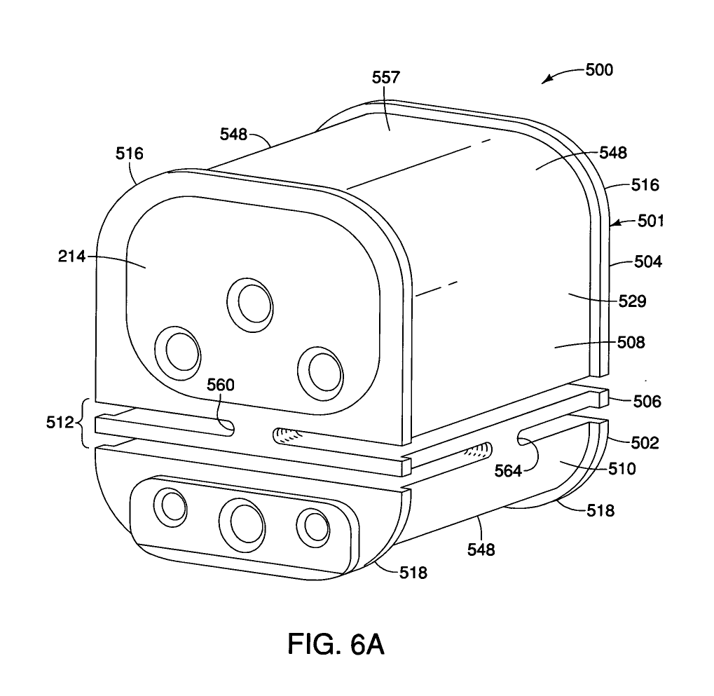

A general arrangement for a preferable mandrel spring system 230, which can be used for the mandrel spring 206 of FIG. 5, is depicted in a plan view in FIG. 6. FIG. 6 is a plan view of the first mandrel part 202, showing the underside surface 220 of the first mandrel part (this surface 220 being oriented essentially parallel to the underside surface 222 of the second mandrel part 204, FIG. 5). The mandrel spring system 230 includes a spring component 232 which allows resilient axial movement (in direction “X”, FIG. 5) between the first mandrel part 202 and the second mandrel part 204. The mandrel spring system 230 further includes a first motion restricting component 234 which assists in restricting motion of the first and second mandrel parts (202, 204) in the “Y” direction, and a second motion restricting component 236 which assists in restricting motion of the first and second mandrel parts (202, 204) in the “Z” direction. In one variation the first and second motion isolation components 234, 236 can be augmented with, or replaced by, one or more torsional restricting members 238 and 240. Torsional restricting members 238 and 240 can be, for example, curvilinear leaf spring elements secured (by welding or the like) at a first end 242 to the underside surface 220 of the first mandrel part 202, and secured (by welding or the like) at a second end 244 to the underside surface 222 of the second mandrel part 204. Torsional restricting members 238 and 240 can thus resist clockwise (“CW”) and counterclockwise “CCW”) rotational motions of the first and second mandrel parts (202, 204) with respect to one another, and thus restrict movement on the mandrel parts 202, 204 with respect to one another in the “Y” and “Z” directions. In general, the mandrel spring 206 can be a unitary spring, or can be a mandrel spring system 230. The mandrel spring system 230 includes at least one spring component 232 configured to provide a biased spring action along axis “X” (FIG. 5) which is parallel to windings of an optical fiber supported on optical fiber support surfaces 208 and 210 (see FIG. 7), and at least one motion restricting component (234, 236, 238, and/or 240, FIG. 6) which is configured to restrict motion of the first and second mandrel parts (202, 204) in one or both of directions “Y” and “Z” (FIG. 6). The mandrel spring system 230 can thus be either an assembly of individual component parts (e.g., axial spring 232 along with directional restricting components 234, 236, 238 and/or 240), or a singular integrated spring system configured to provide enhancement of motion in a first direction (e.g., in direction “X”, FIG. 5) while reducing motion in second and third directions (e.g., directions “Y and “Z”, FIG. 5) which are orthogonal to the first direction. Preferably, the mandrel spring 206 is configured to allow relative motion of the first and second mandrel parts (202, 204) in a direction (“X”) which is perpendicular to the opposing planar surfaces (220, 222) of the mandrel parts, while restricting movement in directions (Y, Z) which are parallel to the opposing planar surfaces.

While the first and second mandrel parts 202, 204 are depicted in FIG. 5 as defining generally parallel opposed planar surfaces 220 and 222, this is not a requirement. The surfaces 220 and 222 of the respective first and second mandrel parts 202, 204 can be other than planar, and can also be placed in a non-parallel arrangement with respect to one another. Further, in a cross section parallel to the optical fiber windings (152, FIG. 7, described below), the mandrel 200 is essentially rectangular in shape with rounded corners (248) at intersecting sides (e.g., top side 227 and right side 229, FIG. 5) of the essentially rectangular shape.

The dimensional shape of the mandrel 200 of FIG. 5 is selected to impart significant Rayleigh scattering signal input to the optical fiber (not shown in FIG. 5), while reducing optical effects of turnings of the optical fiber about the corners (248) of the first and second mandrel parts 202, 204. In general, a generally rectangular shape (in cross section along the direction of the optical fiber windings 152, FIG. 7) of the mandrel 200 is desirable in order to provide a relatively large dimension in the direction “X”, which in turn allows for more length of the optical fiber to experience strain in the direction of deformation (i.e., in direction “X”). Further, the radius of the edges 248 is selected so as to not over-bend the optical fiber (and thus generate too much stress on the fiber, and thus loss of signal). In one example the mandrel 200 is defined by the following dimensions: a horizontal length “ML” (FIG. 5) of the mandrel surfaces 208, 210 over which the optical fiber is wound of about 0.90 inches; a mandrel height “MH” of the mandrel 200 (excluding the retaining lips 216, 218) of about 0.94 inches; a mandrel width “MW” (excluding the retaining lips 216, 218) of about 0.88 inches; and an optical fiber support surface corner radius “MR” (for the fiber supporting surfaces 208, 210 at corners 248, but not including the lips 216, 218) of about 0.25 inches. These dimensions provide for a relatively small overall sensor (132, 134, 136, FIG. 4) which allows for smaller sensor pods (108) to be used, and thus for the sensor array 100 to be placed in small diameter boreholes.

In general, the dimensions of the vector mandrel 200 are preferably within the following ranges: the horizontal length “ML” (FIG. 5) of the mandrel surfaces 208, 210 over which the optical fiber (150, 152) is wound is between about 0.5 inches and 1.5 inches; the height “MH” of the mandrel 200 (excluding the retaining lips 216, 218) is between about 0.5 inches and 1.5 inches; the width “MW” of the mandrel (excluding the retaining lips 216, 218) is between about 0.5 inches and 1.5 inches; and the radius “MR” of the fiber supporting surfaces 208, 210 at the corners (not including the lips 216, 218) is between about 0.1 inches and 0.4 inches. Mandrels (200) having dimensions outside of these preferable dimensions can also be used for a Rayleigh vector sensor, and the upper and lower limits of the dimensions will depend on the type (and diameter) of the optical fiber being used, packaging considerations (i.e., fitting the optical fiber sensors 132, etc. within a sensor pod 108, FIG. 4), and the environment in which the optical fiber sensors will be placed.

An alternative arrangement of a vector mandrel (500) that can be used for a Rayleigh vector sensor (e.g., 132, FIG. 4) is depicted in FIGS. 6A through 6D. FIG. 6A is an isometric view of the mandrel 500; FIG. 6B is a front view of the mandrel 500; FIG. 6C is a side view of the mandrel 500; and FIG. 6D is a cross sectional view of the mandrel 500 as per FIG. 6B. FIGS. 6A through 6D will be described together. The mandrel 500 includes a unitary mandrel body 501 and the slug 214 (described above). The mandrel body 501 includes a first mandrel part 502 and a second mandrel part 504 which are spaced apart from one another by a mandrel gap 512. The mandrel 500 includes a mandrel spring member 506 which is positioned in the mandrel gap 512 between the first and second mandrel parts (502, 504). The mandrel spring 506 is a plate spring (described more fully below). The first mandrel part 502 can be secured to a sensor pod (108, FIG. 4), and the second mandrel part 504 of the mandrel 500 is unmounted. The second mandrel part 504 can include the slug 214 of a heavy (i.e., dense) metal in order to increase the mass of the second mandrel part, as described above. The mandrel first part 502 defines a first optical fiber support surface 510 which supports windings of the optical fiber (not shown in FIG. 6A, but depicted as 150 in FIG. 7). Likewise, the mandrel second part 504 defines a second optical fiber support surface 508 which supports windings of the optical fiber. When the optical fiber is wound onto the fiber support surfaces 508 and 510 (as depicted in FIG. 7, described below), the optical fiber spans the mandrel gap 512. The mandrel first part 502 can include retaining flanges 518 to prevent windings of the optical fiber from slipping off of the fiber support surface 510. Likewise, the mandrel second part 504 can include retaining flanges 516 to prevent windings of the optical fiber from slipping off of the fiber support surface 508. In a cross section parallel to the optical fiber windings (152, FIG. 7, described below), the mandrel 500 is essentially rectangular in shape with rounded corners (548) at intersecting sides (e.g., top side 527 and right side 529, FIG. 6A) of the essentially rectangular shape.

The mandrel spring 206 is isolated between the mandrel first part 502 and the mandrel second part 504 by spring connecting members (which can be seen in FIG. 6A as components 560 and 564). FIG. 6B is a front view of the mandrel 500, and depicts that the mandrel body 501 can be defined by a first side 550 and an opposite second side 552. FIG. 6C is a side view of the mandrel 500, and depicts that the mandrel body 501 can further be defined by a first end 554 and an opposite second end 556. FIG. 6B depicts first and second lower spring connecting members 564 and 566 (respectively), and FIG. 6C depicts first and second upper spring connecting members 560 and 562 (respectively). The section line (“6D-6D”) through FIG. 6B cuts through the first and second upper spring connecting members 560 and 562, and this section is depicted in FIG. 6D. In FIG. 6D the view is a plan view of the mandrel spring 506 (a plate spring) as will be seen from the section “6D-6D” of FIG. 6B, and also shows the cross section of the first and second upper spring connecting members 560 and 562. Also in the section view of FIG. 6D are shown the first and second lower spring connecting members 564 and 566 (respectively). In FIG. 6D the mandrel spring is indicated as also being defined by the respective first and second ends 554 and 556 of the mandrel body 501 (see FIG. 6C), as well as being defined by the respective first and second sides 550 and 552 of the mandrel body 501 (see FIG. 6B). The upper spring connecting members 560, 562 are attached at a first end (not numbered) of the upper spring connecting members 560, 562 to the underside surface 522 (FIG. 6B) of the mandrel second part 504, and are attached at a second end (also not numbered) of the upper spring connecting members 560, 562 to an upper surface 570 (FIGS. 6B and 6D) of the mandrel spring 506. Likewise, the lower spring connecting members 564, 566 are attached at a first end (not numbered) of the lower spring connecting members 564, 566 to the underside surface 520 (FIG. 6C) of the mandrel first part 502, and are attached at a second end (also not numbered) of the lower spring connecting members 564, 566 to a lower surface 572 (FIGS. 6B and 6D) of the mandrel spring 506. As can be appreciated from FIG. 6D, the spring connecting members (560, 562, 564 and 566) are preferably positioned proximate the respective edges (554, 556, 552 and 550) of the mandrel spring 506. In this way forces exerted on the mandrel spring 506 by the spring connecting members (560, 562, 564 and 566) will exert the maximum possible deflective force (for the shown arrangement) to the edges 554, 556, 552 and 550 of the mandrel spring 506, thus allowing maximal deflection of the mandrel spring 506 (based on seismic energy inputs to the mandrel first part 502). This will in turn maximize the opening and closing of the mandrel gap 512 (again, based on seismic energy input to mandrel first part 502), thus imparting the maximum strain (or relief of strain) to the optical fiber windings (152, FIG. 7, described below) about the mandrel body 501, thereby maximizing the signal generated by the optical fiber windings 152.

Following the above description, when the mandrel first part 502 is subjected to a compressive energy force (by way of being attached to a sensor pod (108, FIG. 4) which is in turn coupled to an earth formation (e.g., in FIG. 3 if the sensor pod 108 is in contact with the borehole wall 21), then the lower spring connecting members (564, 566, FIG. 6D) will press against the mandrel spring lower surface 572 (FIG. 6C) at respective edges 552 and 550 of the plate spring 506, and the upper spring connecting members (560, 562, FIG. 6D) will exert an essentially equal and opposite responsive compressive force against the mandrel spring upper surface 270 (FIG. 6C) at respective edges 554, 556 of the mandrel plate spring 506. This will cause the mandrel plate spring 506 to deform into a concave shape (with respect to FIGS. 6B and 6C—i.e., with the spring center “SC” of FIG. 6D moving downward into the sheet). Similarly, when the mandrel first part 502 is subjected to a tensile energy force (by way of being attached to a sensor pod (108, FIG. 4), as just described), then the lower spring connecting members (564, 566, FIG. 6D) will pull against the mandrel spring lower surface 572 (FIG. 6C) at respective edges 552 and 550 of the plate spring 506, and the upper spring connecting members (560, 562, FIG. 6D) will exert an essentially equal and opposite responsive tensile force against the mandrel spring upper surface 270 (FIG. 6C) at respective edges 554, 556 of the mandrel plate spring 506. This will cause the mandrel plate spring 506 to deform into a convex shape (with respect to FIGS. 6B and 6C—i.e., with the spring center “SC” of FIG. 6D moving outward from the sheet). Thus, the mandrel spring 506 of the mandrel 500 can act like a diaphragm, flexing into concave and convex shapes depending on the direction of energy input. Preferably the upper spring connecting members 560, 562 are oriented along a first line which passes through the spring center “SC” of the mandrel plate spring 506 (see FIG. 6D), and the lower spring connecting members 564, 566 are also oriented along a second line which passes through the spring center “SC” of the mandrel plate spring 506, wherein these first and second lines are orthogonal to one another. More preferably the upper spring connecting members 560, 562 are disposed with respect to the mandrel plate spring 506 at a midpoint between the first side 550 and the second side 552 of the mandrel spring (see FIG. 6D), and the lower spring connecting members 564, 566 are disposed with respect to the mandrel plate spring 506 at a midpoint between the first end 554 and the second end 556 of the mandrel spring 506.

A further study of FIG. 6D indicates that the spring connecting members 560, 562, 564 and 566 will resist motion of the first and second mandrel parts (502, 504, FIGS. 6A-6C) in lateral directions “Y” and “Z”, thus constraining relative movement of the first and second mandrel parts in direction “X” (indicated by an axis into and out of the drawing sheet). Likewise, the spring connecting members 560, 562, 564 and 566 will resist rotational motion of the first and second mandrel parts (502, 504, FIGS. 6A-6C) about the mandrel spring 506 in clockwise (“CW”) and counter-clockwise (“CCW”) directions. Accordingly, the mandrel spring configuration depicted in FIGS. 6A through 6D provides good cross axial isolation of energy received by the mandrel first part 502, thus allowing for true vector (i.e., directional) sensing.

The mandrel body 501 of mandrel 500 can be fabricated from a single piece of material. In a preferred configuration, the mandrel body 501 is fabricated from a single piece of spring steel. The forming of the spring connecting members (560, 562, 564, 566) and the mandrel spring (506) can be accomplished by machining a single block of steel having spring properties using machining techniques such as milling, plasma cutting and water cutting. Alternately, the mandrel body 501 of mandrel 500 can be fabricated from component parts which can be joined together by processes such as welding, fusing, gluing, brazing, etc. When the mandrel body 501 is fabricated from component parts, the first and second mandrel parts (502, 504) can be fabricated from a material not specifically selected for having spring properties, while the spring member 506 can be fabricated from a material specifically selected for having spring properties. In this instance the first and second mandrel parts (502, 504) can be fabricated from a material selected for having density properties in order to increase the mass of the mandrel body (501) in order to resist motion imparted by seismic forces (and thus impart more of the seismic energy into the spring member 506).

In an alternative arrangement to that depicted in FIGS. 6A-6D, the spring member 506 can be other than rectangular shaped. For example, the spring member 506 can be elliptical, circular or some other shape (as viewed in the plan view of spring 506 of FIG. 6D). Preferably, the spring member 506 is dimensioned such that the edges of the spring member do not extend beyond the sides (550, 552, FIG. 6B) of the mandrel body 501 (as indicated by FIG. 6D). It will be noted that the sides 550, 552 of the spring member 506 of FIG. 6D are similarly numbered as to the sides 550, 552 of the first mandrel part 502 and the second mandrel part 504. However, it is not a requirement that the sides 550, 552 of the first and second mandrel parts (502, 504), and the sides of the spring member 506 all be in alignment with one another. For example, the sides (550, 552) of the spring member 506 can extend beyond, or be inside of, the sides of the first mandrel part 502 and/or the second mandrel part 504. In yet another alternative arrangement the spring member 506 can be a bellows spring, a Bellville spring, a coil spring, a composite spring (i.e., a multi-component spring), or other type of spring which can be placed in a generally planar arrangement in the gap (512, FIG. 6A) between the first and second mandrel parts 502 and 504. In an alternative arrangement the upper spring connecting members 560, 562 can be oriented proximate the sides 564, 566 of the spring member 506, and the lower spring connecting members 564, 566 can be oriented proximate the end 560, 562 of the spring member 506.

While FIG. 6D depicts the vector mandrel 500 of FIGS. 6A-6C as having two upper spring connecting members (560, 562), and two lower spring connecting members (564, 566), in an alternative arrangement the mandrel 500 can include only one upper spring connecting member, and/or only one lower spring connecting member. Further, while the upper and lower spring connecting members (560, 562, 564, 566) are depicted in FIGS. 6A-6D as being post-like members, the spring connecting members can be other shapes (such as arcuate-shaped members curving along the upper and lower surfaces 570, 572 of the spring member 506).

Assembly of Optical Fiber Sensor

Turning now to FIG. 7, an assembled Rayleigh vector sensor 250 is shown in a side view. The vector sensor 250 includes the vector mandrel 200 of FIG. 5, and is wound with an optical fiber 150, producing a plurality of optical fiber windings 152 about the optical fiber support surfaces 208, 210 of the mandrel. The mandrel 200 defines an optical fiber winding axis 215 (see also FIG. 5) about which the optical fiber 150 is wound. In FIG. 7 the optical fiber 150 is depicted with a greatly exaggerated diameter so that the individual windings 152 can be viewed. As can be seen, the optical fiber windings 152 span the mandrel gap 212 such that then the mandrel first and second parts 202, 204 move apart (i.e., in direction “X”) the optical fiber windings are strained, thus producing a change in the Rayleigh backscattering effect provided by the optical fiber 150. In one example the length of optical fiber 150 wound about the mandrel 200 (to produce the optical fiber windings 152) is about 10 meters. The length of optical fiber 150 wound about the mandrel 200 (to produce the optical fiber windings 152) can be between about 2 meters and 25 meters, although the length can vary based on the dimensions of the mandrel 200, the dimensions of the optical fiber 150, and the intended application.

Preferably, a single optical fiber is used for all of the optical fiber vector sensors (250, FIG. 7) in the sensor array (100, FIG. 2). That is, at each vector mandrel 200 (FIGS. 5 and 7) a first length of the optical fiber 150 is wound about the mandrel, and between the various sensor levels (e.g., 102, 104, FIG. 2) a second length of the optical fiber separates and connects the sensor levels. In this way the optical fiber vector sensors (250) at each sensor level (102, 104), and the sensor levels themselves, can be connected in series by a single optical fiber 150. In one alternative arrangement more than one optical fiber can be used in the sensor array 100 (FIG. 2). For example, three separate optical fibers can be used, one fiber for each of the optical fiber sensors 250 oriented in each of the three orthogonal directions (A, R₁ and R₂, FIG. 1). That is, a first optical fiber for optical fiber sensors oriented in direction A, a second optical fiber for optical fiber sensors oriented in direction R₁, and a third optical fiber for optical fiber sensors oriented in direction R₂. Preferably the length of the optical fiber 150, 152 which is wound about the mandrel 200 (FIG. 7) is a length of optical fiber which does not include a fiber Bragg grating.

Preferably, the optical fiber windings 152 about the mandrel 200 are prestressed (i.e., placed in tension) during assembly of the optical fiber sensor 250. In this way changes in both compression and tension imparted to the optical windings 152 can be detected without the optical fiber windings becoming slack. One method to achieve this prestressing of the optical fiber windings 152 is to compress the first and second mandrel parts (202, 204, FIG. 7) towards one another against the biasing force of the mandrel spring 206 (FIG. 5) prior to winding the optical fiber 150 onto the mandrel. The optical fiber 150 can be wound onto the mandrel 200 while the first and second mandrel parts 202, 204 are compressed together, and once the optical fiber is wound onto the mandrel the compressed mandrel parts are released. The mandrel spring 206 then exerts a prestressed tension force onto the optical fiber windings 152. An exemplary pretension load of between about 5-50 lb can be applied to the optical fiber winding 152 in order to achieve the desired prestressing of the optical fiber. The exact preload applied to the optical fiber 150 can vary depending on the conditions expected to be encountered by the sensor 250. In one example a preload of about 50 grams is applied to the optical fiber 150. The preload tension applied to the optical fiber 150 is a factor in defining the sensitivity of the fiber.

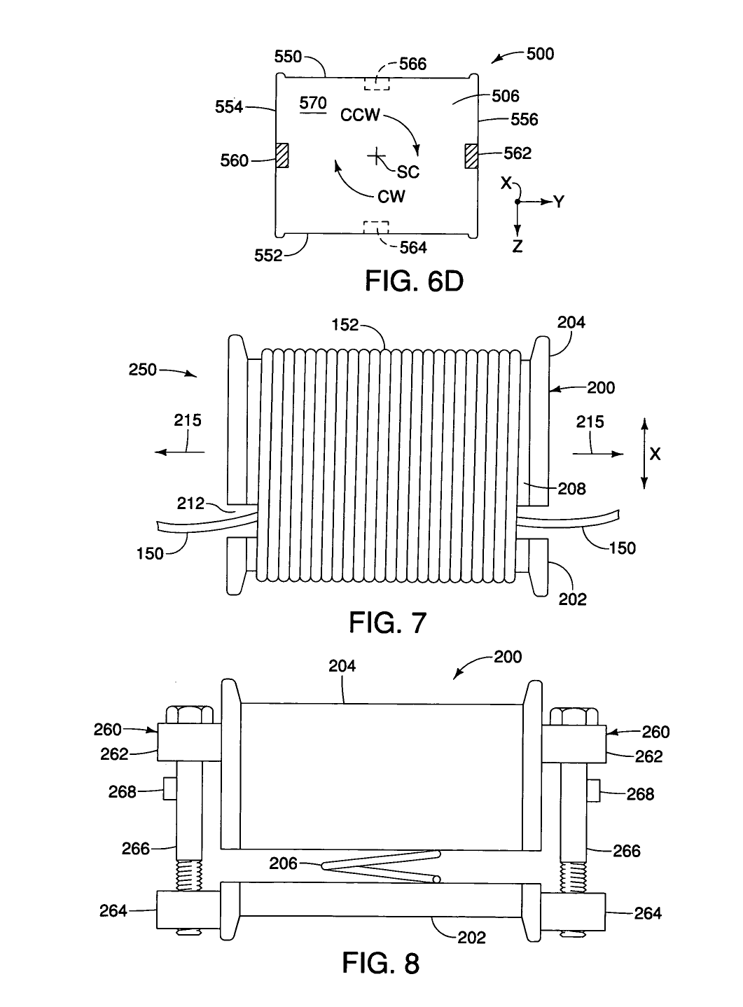

FIG. 8 is a side view of the mandrel 200, and including a mandrel preload compression apparatus (not specifically numbered). The mandrel preload compression apparatus includes a pair of mandrel compression assemblies 260. Each mandrel compression assembly includes a first lug 262 and a second lug 264. First lugs 262 are temporarily secured to the mandrel second part 204, while second lugs 264 are temporarily secured to the mandrel first part 202. Lugs 262 and 264 can be temporarily secured to the mandrel parts 202, 204 by screws or the like. A threaded bolt 266 is placed through a hole (not shown) in the first lug 262, and engages a threaded hole (not shown) in the second lug 264. Thus, by rotating the bolts 266 the mandrel parts 202, 204 are brought closer together, resisted by the biasing force of the mandrel spring 206. The amount of preload applied to the mandrel 200 by the mandrel compression assemblies 260 can be measured by a load cell, such as load cells 268 on bolts 266. Once the optical fiber (150, FIG. 7) is wound around the mandrel 200, the mandrel compression assemblies 260 can be removed from the mandrel.

Assembly of the Rayleigh Vector Sensor Array

The Rayleigh vector sensor array 100 (FIG. 2), which will also be referred to herein as the sensor array, is generally shown and described above with respect to FIGS. 2-4. That is, the sensor array 100 includes a plurality of spaced-apart sensor pod housings 106 (FIG. 2) which are connected to one another. In one embodiment, the sensor pod housings 106 are connected to one another by drill pipe or production tubing that serves as the hydraulic tubing 110 which can be used to contain hydraulic fluid used deploy the sensor pod (108, FIGS. 2 and 3) into contact with the borehole wall 21. When means other than a hydraulic deployment system are used to place the sensor pods 108 into contact with the borehole wall, then the sensor pod housings 106 can be connected to one another by connectors other than hydraulic tubing. In any event, the sensor pod housings 106 of the sensor array 100 are connected to one another in a spaced apart arrangement by sensor pod connectors (not specifically shown or numbered in the accompanying figures, but which can be generically represented by the hydraulic tubing 110 of FIG. 1). As indicated, each sensor pod housing 106 houses a sensor pod 108, and each sensor pod supports one or more optical fiber sensors (132 of FIG. 4, and 250 of FIG. 7). Referring to FIG. 4, the multiple sensor pods 108 of the sensor array 100 (FIG. 2) can be connected to one another by signal tubing 131, which can be attached to the sensor pod 108 by a weldment 133 or the like. The signal tubing 131 can be, for example, stainless steel tubing, and is preferably (but not necessarily) separate from the sensor pod connectors (e.g., 110, FIG. 2). A length 151 of the optical fiber 150 within the signal tubing 131 places the optical fiber sensors (132, 134, 136, FIG. 4) in one sensor pod 108 in serial communication with the optical fiber sensors in an adjacent sensor pod. Thus, the sensor array can include a single optical fiber 150 having first lengths (optical fiber windings 152, FIG. 7) which are wound about mandrels (200, FIG. 7) to create optical fiber point sensors (250, FIG. 7), and second lengths (151, FIG. 4) which are disposed between sensor pods 108 at different levels (e.g., 102, 104, FIG. 2) within the sensor array 100. As described herein, the return signals from the optical sensor array 100 include highly amplified Raleigh backscattered light from the lengths of optical fiber (windings 152) wound around the mandrels (200) at the optical point sensors 250, as well as Raleigh backscattered light from the lengths of optical fiber (151) between the sensor levels (102, 104). Telemetry circuitry (describe below) can be used to distinguish these two sources of backscattered light from the sensor array 100. In this way, the lengths of optical fiber 151 between the sensor levels (102, 104) can act as distributed optical sensors (versus the point optical sensors 250).

Following the last optical fiber sensor (250) in the sensor array 100, the optical fiber 150 terminates, typically using light absorbing optical gel at the end of the fiber.

The Rayleigh Vector Sensor System

The Rayleigh vector sensor system disclosed and described herein includes a plurality of the Rayleigh vector sensors (e.g., 250, FIG. 7), and each such sensor is configured to dynamically measure seismically induced strain in the single mode optical fiber (150) over a spatial resolution length defined by a compensating interferometer path mismatch of a laser light source (described more fully below) by using an interferometric coherent optical reflectometry (COR) technique to transmit position dependent fiber strain information to recording instruments at the formation surface (e.g., surface 11, FIGS. 1 and 2). In coherent optical time domain reflectometry, travelling pulse pairs of coherent light define individual fiber length sections. When a laser is used as the pulse source, and the Rayleigh backscatter from select fiber sections of the fiber is made to interfere, the resultant interference signal allows recording and analysis of strain at multiple sensor positions along a single continuous optical fiber (and thus along a sensor array). A low intrinsic backscatter (about half the loss of standard fiber) allows most of the light to continue to move forward, and about 0.2 dB/km in an SMF28 fiber due to Rayleigh backscatter, that is made to interfere with itself or a reference pulse to obtain the local perturbation/strain in coherent reflectometry. Hence, many continuous Rayleigh vector sensors can be virtually placed along the optical fiber by the choice (selection) of laser pulse repetition rate and width and compensator pulse delay.

As indicated above, the method for obtaining useful data from the Rayleigh vector sensor system is based on a coherent optical reflectometry system, which interrogates the Rayleigh vector sensors by sending one light pulse at a time into the optical fiber and recording the intrinsic Rayleigh backscatter generated from fiber impurities and dopants in the fiber. A Rayleigh vector sensor sensing length per sensor is defined by the compensator path mismatch which is greater or equal to the pulse width. For example, if a 20 ns pulse width is used the highest spatial resolution attainable is 2 m. Shorter pulse widths can be used for higher spatial resolution. The strain in the optical fiber at each Rayleigh vector sensor is measured interferometrically by comparing the changes in the relative phase angle between the backscattered light of the two generated light pulses (described more below) from the selected sensing length of the Rayleigh vector sensor.

The interrogation technique for the Rayleigh vector sensor is accomplished in general by monitoring and processing the optical signals which are backscattered in a fiber caused by Rayleigh scattering (which results from random fluctuations in the index of refraction of the fiber). This is essentially the principle used in optical time domain reflectometry (OTDR), which implements an incoherent Rayleigh backscatter measurement process to identify optical loss characteristics of a fiber over its length. Rayleigh vector sensor interrogation for the disclosed embodiments can involve the measurements of coherent Rayleigh backscatter. There are basically two known different time domain interrogation approaches for Coherent Rayleigh based systems: (i) self-interfering; and (ii) demodulated. However, there are a number of problems with the self-interfering pulse approach which render it generally less preferable for use with the Rayleigh vector sensor. Therefore, the preferred time domain interrogation approach for use with the Rayleigh vector sensor system is the demodulated Rayleigh approach (discussed below).

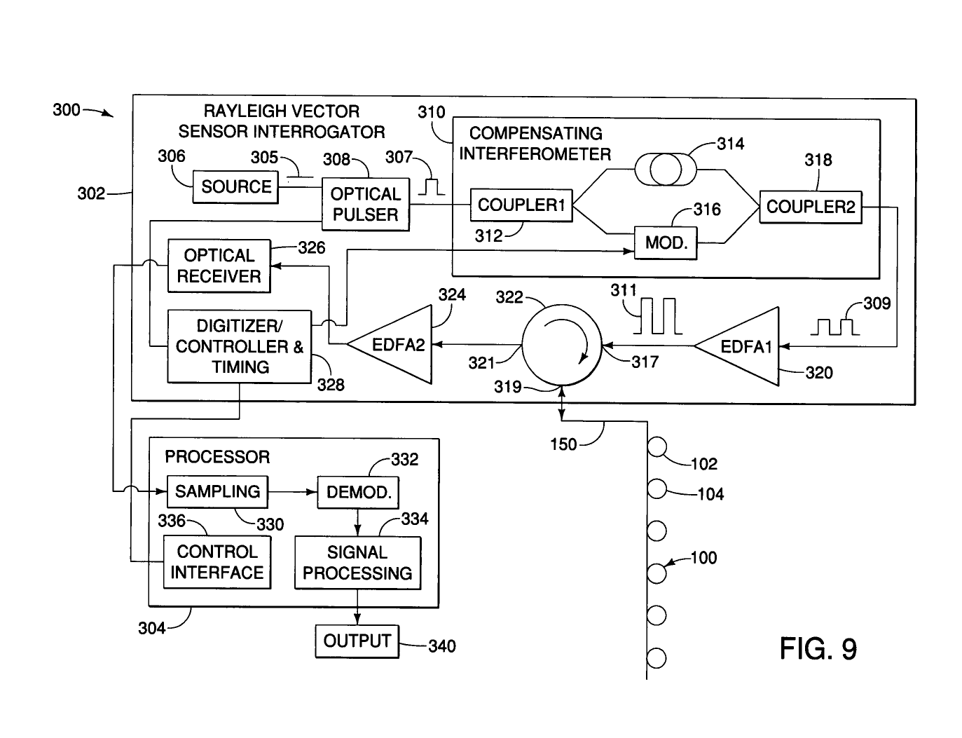

FIG. 9 is a schematic diagram of one embodiment of a Rayleigh vector sensor fiber optic geophone system 300. The system 300 includes the following major components: a Rayleigh vector sensor array 100; a telemetry cable (indicated by optical fiber 150); a Rayleigh vector sensor interrogator 302; and a signal processor 304. The Rayleigh vector sensor interrogator 302 and the signal processor 304 can be collectively and generally described as circuitry which enable the operation of the sensor system 300. The Rayleigh vector sensor array 100 includes a plurality of Rayleigh vector sensor levels (e.g., 102, 104, as per FIG. 2), and each sensor level includes a sensor pod (not shown, but similar to sensor pod 108 of FIG. 4) housing at least one Rayleigh vector sensor, and preferably three orthogonally oriented Rayleigh vector sensors (e.g., sensors 132, 134, 136, FIG. 4).

We will now describe the various components of the Rayleigh vector sensor interrogator 302 and the signal processor 304, and will describe the operation of the system 300 further below. The Rayleigh vector sensor interrogator 302 includes a source 306 of optical energy. The source 306 can be a high coherence continuous wave laser generating a laser output 305 at 1.5 μm (for example) to a single mode optical fiber (not numbered). The output 305 in the single mode fiber is input to an optical pulser 308 (or optical pulse generator) which converts the continuous wave form of the source output 305 into a square wave pulse form 307. The square wave optical pulse 307 is then input to a compensating interferometer 310. The compensating interferometer 310 includes a first optical coupler 312 (“COUPLER1”) which splits the square wave optical pulse 307 into two parallel optical arms which are each then sent to separate optical fibers (not numbered). The first arm of the optical square wave signal 307 is provided to a delay line interferometer 314 which imposes a time delay on the first arm. The delay device 314 can be, for example, a Mach-Zehnder interferometer. The time delay imposed on the first arm of the square wave optical signal 307 can be, for example, a 20 ns delay. The second arm of the square wave signal (output from the first coupler 312) is provided to a phase modulator 316 (“MOD.”), which imposes a phase change to the second arm of the square wave optical signal. The outputs of the delay device 314 and the phase modulator 316 are then combined using a second optical coupler 318 (“COUPLER2”), resulting in an output from the compensating interferometer 310 of the two-pulse optical signal 309 in a single optical fiber (not numbered). The two-pulse optical signal 309 thus includes a phase modulated first optical square wave pulse having the phase modulation imparted by the modulator 316, and second optical square wave reference pulse having the time delay imparted by the delay device 314. The two-pulse optical signal 309 is then input to a first amplifier, which can be the erbium doped fiber amplifier (EDFA) 320 (“EDFA1”). The first EDFA amplifies the two-pulse optical signal 309 to provide the amplified two-pulse optical signal 311. The amplified two-pulse optical signal 311 is then passed into an optical circulator 322. The optical circulator 322 is a three-pole fiber-optic component that can be used to separate optical signals that travel in opposite directions in a single optical fiber in order to achieve bi-directional transmission of optical signals over a single fiber. The first pole 317 of the optical circulator 322 receives the amplified two-pulse optical signal 311; the second pole 319 of the optical circulator sends the two-pulse optical signal 311 to the Rayleigh vector sensor array 100 (via optical fiber 150); and the third pole 321 of the optical circulator receives the return optical signals from the sensor array 100 and sends the return optical signals to a second erbium doped fiber amplifier 324 (“EDFA21”). The output from the second optical amplifier 324 (i.e., the amplified return signal from the sensor array 100) is then sent to an optical receiver 326, which converts the optical signal into an electronic (or electrical) signal which is representative of the return optical signals, and in particular of backscattered light information contained within the optical return signals. The Rayleigh vector sensor interrogator 302 thus generates two input (or reference) optical pulse signals (one phase delayed over the other, and with an imposed time delay between the signals) into the sensor array 100, receives return signals from the sensor array (as modified by the optical fiber sensors 250 in the sensor array), and converts the received (return) optical signals into electrical signals for signal processing.

Preferably, the pulse width of the interrogating pulses (311) is twice the light round trip transit time between Rayleigh vector sensor levels (e.g., 102, 104). Thus, for a 2 m length of fiber per sensor (an exemplary length of sensor fiber in the fiber optic geophone between scattering sections) the pulse width is 20 ns. The rate of the phase-modulated pulses (311) sent by the interrogator (310) to interrogate the Rayleigh vector sensors will depend on the overall length of the optical fiber cable. The maximum pulse rate for the interrogator 310, which is the optical equivalent of sampling rate for electronic systems, is twice the light transit time in the lead in the optical fiber cable and the array 100 because in the time domain modulation interrogation scheme performance is typically best achieved if only one pulse travels in the sensor fiber at a time. Thus, for a 10 km (about 30,000 ft) long optical fiber 150, a maximum sampling rate of about 0.1 ms yields a Nyquist frequency of about 5,000 Hz.

The electrical signal output from the optical receiver 326 of the Rayleigh vector sensor interrogator 302 of the sensor system 300 is then provided to the processor 304. More specifically, the output from the optical receiver 326 is passed to the sampler 330 which extracts the electrical signals in the time domain. The time domain extracted signals (from the sampler 330) are then passed to the demodulator 332. The demodulator can be a phase modulation (PM) demodulator, which is configured to extract the information-bearing signal (from sensor array 100) from the modulated carrier wave (311). The demodulator 332 can be implemented as an electronic circuit or as computer software. The demodulator 322 extracts phase information from the time domain extracted signals (from the optical receiver 326), and can also determine the sine and cosine of the time domain extracted signals, and can further calculate the tangent values of the time domain extracted signals. The output from the demodulator 332 is then provided to the signal processing module 334. The signal processing module 334 can apply band pass filtering to the received inputs, and can perform cross correlation between theoretical sweeps of the source (signals 311) and the seismic traces from the Rayleigh vector sensors in the array 100 (as received by the optical receiver 326).

The Rayleigh vector sensor interrogator 302 can also include a digitizer/controller and timing module 328. The digitizer/controller and timing module 328 controls timing between the optical pulser 308 and the modulator 316 in order to ensure that the generated optical pulses (307, 309) are synchronized in the time domain. The digitizer/controller and timing module 328 also receives an input from a control interface 336 in the signal processor 304 to regulate the generation of pulses 307 such that the data received from the optical receiver 326 can be processed in accordance with the timing constraints of the signal processor 304.

The output 340 from the signal processor 334 is time-domain data including amplitudes of the signals from the sensor array 100. This time domain amplitude data is generated by the phase change imparted to the reference signals (311) resulting from an amplified Rayleigh backscattering effect imparted to the optical fiber 150 wound around the mandrels 200 (FIG. 7). The time domain amplitude data basically comprises seismic traces of amplitude as a function of time for each Rayleigh vector sensor in each of the three vector directions (A, R₁ and R₂, FIG. 1).

The output data 340 can be further supplemented and processed to derive a better understanding of the formation (or other physical feature) being imaged by the Rayleigh vector sensor array 100. For example, Rayleigh backscattering data from the optical fiber 150 which is located between sensor levels (e.g., levels 102 and 104, FIGS. 2 and 9) can be used to assist in determining arrival times of seismic signals to the different sensor levels, and thus the velocity information of the formation. The output data 340 can also be rotated (by data processing in the signal processor 334) in order to determine the orientation of the return signals. Typically, the output of data from the signal processing unit 334 is provided in a file format known as SEG Y (sometimes SEG-Y, or SEGY), which is one of several standards developed by the Society of Exploration Geophysicists (SEG) for storing geophysical data. (SEG Y is an open standard, and is controlled by the SEG Technical Standards Committee.) The output data 340 can also be processed by hodogram analysis, which is commonly used in borehole seismology to determine arrival directions of waves and to detect shear-wave splitting, and in which data recorded along two or three sensor axes are displayed as a function of time.

It will be understood that the components of the interrogator 302 and the signal processor 304 of FIG. 4 are exemplary only, and can be rearranged as allowed by software, component and signal receiving/transmitting capabilities (e.g., the digitizer/controller 328 can be part of the processor 304). Further, other circuitry and components can be used to accomplish the same result as the system 300 of FIG. 9. It will also be appreciated that the values provided in the above discussion of FIG. 9 (e.g., wavelengths, time delays, frequencies, etc.) are exemplary only. Further, while waveforms 307, 309 and 311 are depicted and described as being square waves, it will be appreciated that waveforms that are less than ideal square waves can also be used, but with some loss of data quality.

Demodulated Interrogation

As indicated above, rather than using the amplitude of the Rayleigh signal, we extract the phase information from the backscattered signal (from the sensor array 100, FIG. 9) by making changes to the interrogator (302) and implement processing steps such that large-angle phase modulation (PM) demodulation can be attained from the demodulator 332. Here, a pulse of light (307) is passed through a compensator (310) to create two pulses (309) separated by path mismatch, and one of the two pulses is modulated (by modulator 316). The resulting train of pulses (311) passes through an optical circulator (322) to the sensor array (100) where Rayleigh backscattered light returns to the receiver (326). The advantage of this technique is: (i) the received signals (from the sensor array 100) contain the modulation terms based on the Rayleigh backscattering effect; (ii) the sensor spatial resolution effectively becomes the distance between the two pulses (309) emitted from the compensator (310) (i.e., equal to the delay in path match); and (iii) interfering scatter terms are better phase matched leading to lower phase noise. Demodulation (by demodulator 332) is accomplished by first extracting quadrature measures (I, Q) from the modulated data, then using inverse trigonometric means to determine A(t)+θ(t) (i.e., amplitude as a function of time, and phase shift as a function of time) on a unit circle and invoking a fringe counting process to measure the optical phase linearly to large angles (for example, 1000's of radians).

Phase Calculation Error

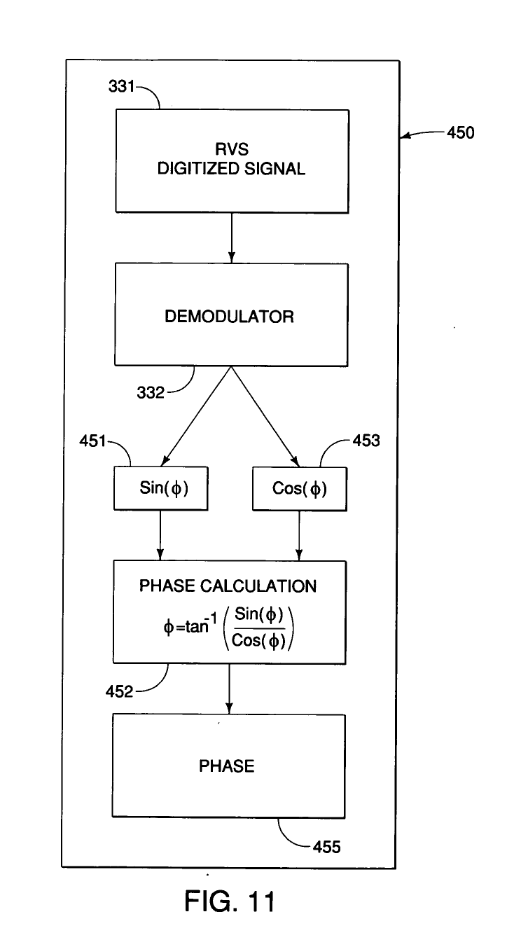

The process of calculating phase from the Rayleigh scattered signal (received from the sensor array 100 by the circulator 322 of FIG. 9) involves a demodulation process to generate quadrature phase terms (sine and cosine, known as I and Q) which are then used to calculate the phase by deriving arc tangent of the ratio of the two quadrature terms. There are several different demodulation methods that can be used such as Phase Generated Carrier (PGC), Heterodyne, and Homodyne, but they share the same idea of deriving two quadrature terms from the optical sensor return signal. FIG. 11 illustrates one such process. FIG. 11 is a schematic diagram depicting a system 450 and a process for determining phase from a Rayleigh scattered signal. The Rayleigh scattered signal 331 can be the digitized (i.e., digital, versus analog) output from the sampling module 330 (FIG. 9) which extracts the electrical signals (from the optical receiver 326) in the time domain. The digitized Rayleigh scattered signal is provided to the demodulator 332 which extracts the following quadrature terms: the sine 451 of the phase (which can also be represented as “I”); and the cosine 453 of the phase (which can also be represented as “Q”). The quadrature terms (451, 453) are then processed in a processor (e.g., 334, FIG. 9) to calculate the phase as the arctangent of the ratio (I/Q), as indicated by 452, resulting in the phase output signal 455.

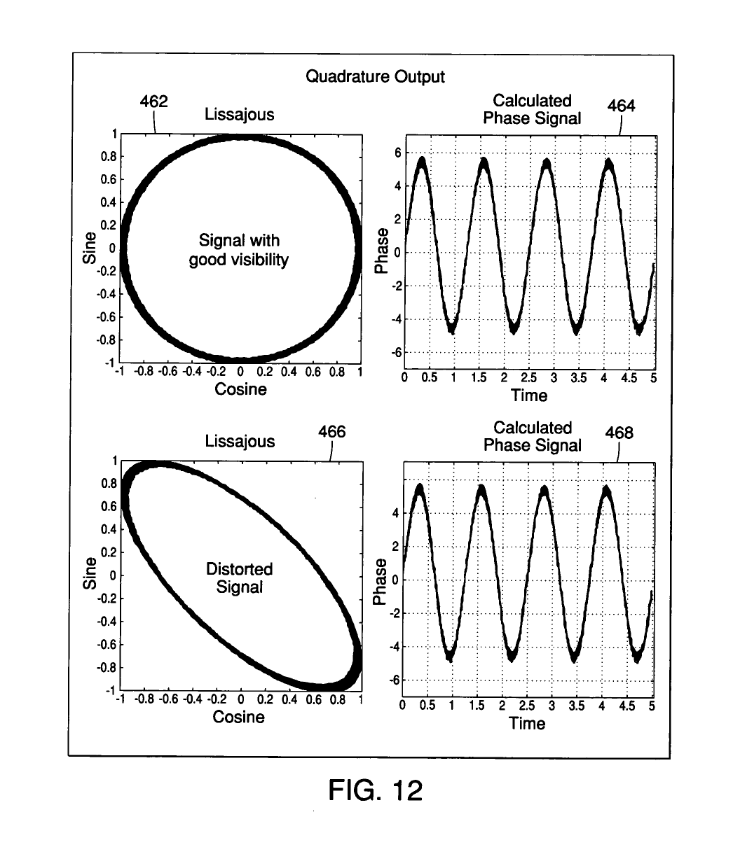

In all cases of demodulated (interferometric) optical sensing, some correction processes are involved in relation to insuring the quadrature terms are accurate, as these affect the accuracy and linearity of the demodulation process. Ideally, the two quadrature terms should form a unit circle centered at origin when plotted on x and y axes. However, due to mismatch in gain, offset, and phase between the two terms, the unit circle can be distorted in shape and/or off centered, and they are preferably both monitored and corrected. If the correction is not done accurately, it will cause distortion in the output phase as shown in FIG. 12. FIG. 12 is a diagram depicting Lissajous diagrams 462 and 466, and respective associated calculated phase signal diagrams 464 and 468. In FIG. 12 Lissajous diagram 462 depicts the ideal unit circle to achieved by graphing quadrature I (sine) as a function of quadrature Q (cosine) of a signal with good visibility, and graph 464 depicts the associated smooth plot of phase as a function of time. This is to be compared to Lissajous diagram 466 wherein a unit circle is not achieved (i.e., the signal is distorted), and the resulting non-smooth graph 468 of phase as a function of time. In order to achieve the ideal unit circle plot 462 (and the resulting smooth phase change graph 464) a sufficient optical sampling rate (e.g., 80 KHz or less) is desirably applied.

Signal Fading

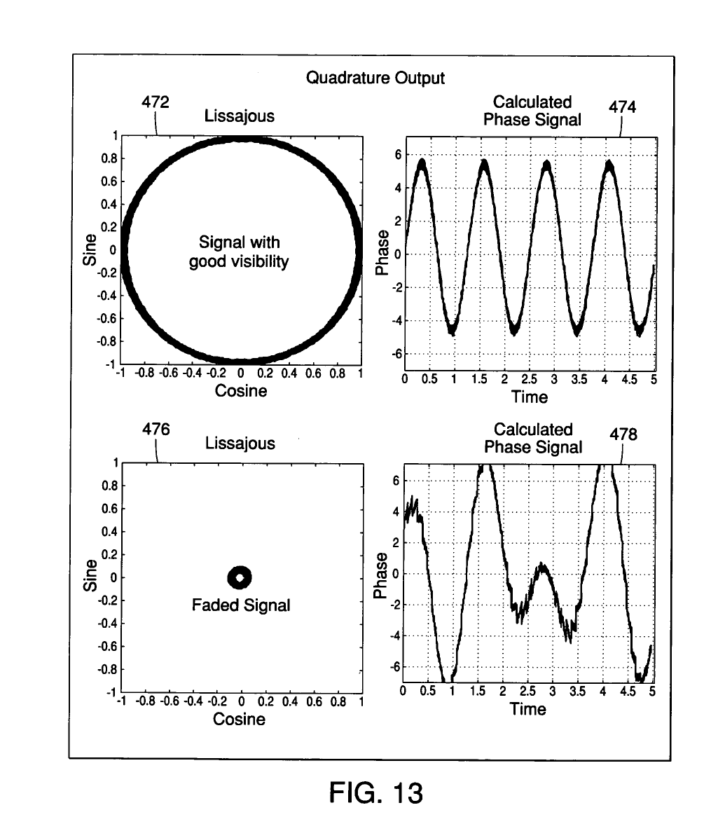

Signal fading occurs when the alternating component (AC) in the Rayleigh scattered signal disappears (i.e., visibility of the AC signal). (Seismic signals are considered to have an alternating component (AC), which conveys the dynamic portion of the signal, as well as a direct component (DC) which is a constant or static underlying signal component.) A graphic illustration of a healthy signal and a faded signal are depicted in FIG. 13 with resulting phase calculation. FIG. 13 depicts examples of high and low visibility AC signals and resulting demodulation signals. The top left image 472 depicts a Lissajous diagram of a signal with good visibility, depicted as a generally unit circle, resulting in the calculated demodulated phase signal plot 474 (i.e., phase as a function of time). The bottom left image 476 depicts a Lissajous diagram of a collapsed unit circle (i.e., a faded signal with low visibility) and the resulting noisy and discontinuous demodulation phase signal 478 (i.e., phase as a function of time). Fading can be caused by two different and independent issues: (i) polarization fading (a well-known phenomenon in optical fiber interferometry); and (ii) ensemble fading (unique to Rayleigh backscattering modulation). Polarization fading can be abated by use of polarization diversity receivers. One approach is to employ polarization diversity receivers in the interferometric interrogator 310. This approach effectively doubles or triples the requirements for optical receivers and digitizers. The ensemble fading approach involves combining multi-wavelength sources and oversampling to only retain high visibility samples which do not present fading, within the whole array data sets. An alternative approach involves combining multi-wavelength sources (or wavelength hopping of a single wavelength source) and oversampling or interleave sampling and selection of only high visibility samples within these data sets which don't present fading. The most appropriate solutions (or combinations thereof) can be implemented to constitute an enhanced method for fade abatement.

Linear Transfer Function of Optical Fiber Used in Rayleigh Vector Sensor

Preferably the Rayleigh vector seismic sensor provides a linear transfer function of the strain from seismic waves traveling in the Earth and coupled into the borehole to the strain generated in the optical fiber that will make up the sensor. This can be determined by testing the sensor by providing a given input signal (e.g., 1G of acceleration) at different frequencies (e.g., between 1 Hz and 2000 Hz), measuring the output, comparing the output to the input, and determining if the correlating coefficient between the input and output is essentially constant over the range of frequencies. If the correlating coefficient remains constant within acceptable limits, then a linear transfer function has been achieved. As can be appreciated, and as discussed above, selecting the parameters of the Rayleigh vector seismic sensor (e.g., the optical fiber to be used, the optical input characteristics, and the processing of the optical outputs) can vary depending on the intended use of the sensor array in order to achieve an acceptable balance between competing factors.

Rayleigh Vector Sensor System Method

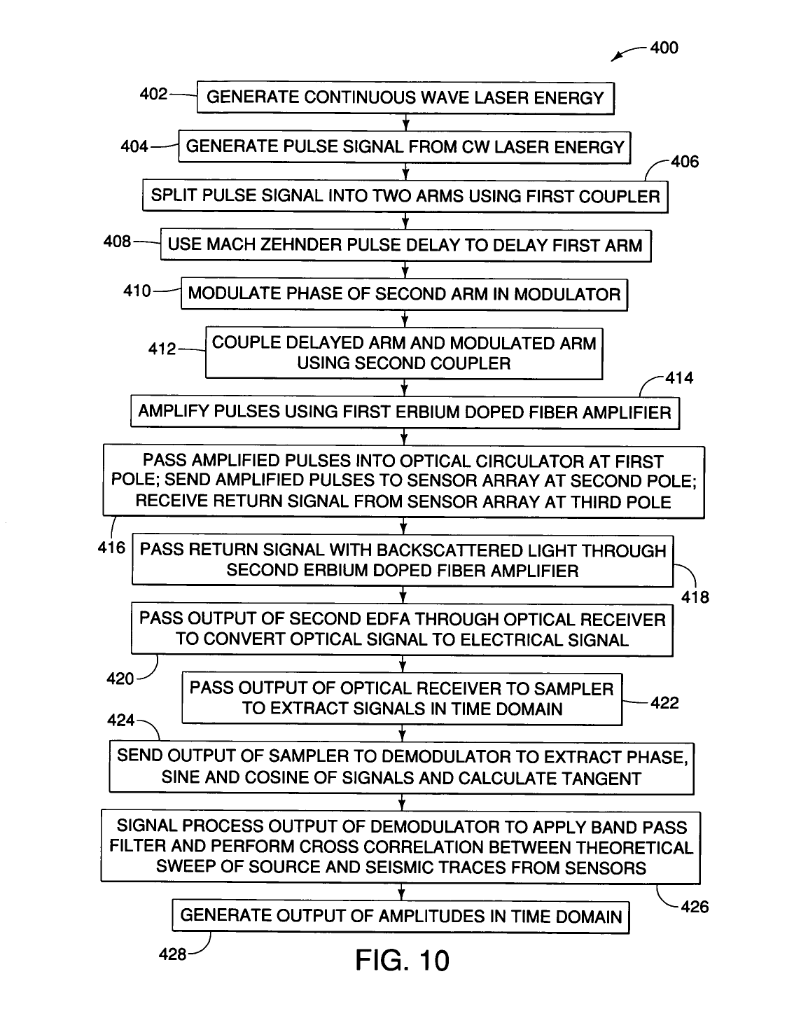

FIG. 10 is a flowchart 400 depicting steps that can be performed in order to obtain data that can be used to generate an image using the Rayleigh vector sensor system (300) described above with respect to the Rayleigh vector sensor system 300 of FIG. 9. The flowchart 400 begins at step 402 by generating continuous wave laser energy (305), which can be done using a continuous wave laser 306. At step 404 a pulse signal (307) is generated from the continuous wave laser energy (305), which can be done using the pulse generator (optical pulser) 308. An exemplary duration of the pulse signal is 20 ns. At step 406 the pulse signal (307) is split into two arms using a first optical coupler (312), and at step 408 a delay is imparted to the first arm. This can be done using an optical delay device (314), such as a Mach-Zehnder pulse delay device. An exemplary delay imparted to the first arm is between 100 ns and 500 ns. At step 410 the second arm of the optical pulse signal is phase modulated using the phase modulator 316. An exemplary phase modulation of the second arm is provided by imposing a sine wave over the pulse signal (307). The imposed wave has a frequency outside of the range of about 0 Hz to about 2,000 Hz (i.e., outside of the typical seismic frequency range), and more preferably outside of the range of about 0-4,000 Hz. Then at step 412 the time-delayed arm and the phase modulated arm of the optical pulse signal are joined together into a single optical fiber using a second optical coupler (318) to produce a two-pulse optical signal (309). At step 414 the two-pulse optical signal (309) is amplified (e.g., using the erbium doped optical fiber amplifier 320) to generate an amplified two-pulse optical signal (311). At step 416 the amplified two-pulse optical signal (311) is directed to a Rayleigh vector sensor array (100). This can be done using an optical circulator 322 such that the down-traveling reference pulses (311) and the up-coming sensor data from the array (100) can be provided on a single optical fiber 150. In step 418 the up-coming return signal from the sensor array (100), which includes the Rayleigh backscattered light, is amplified. This amplification of the return signal can be performed using a second erbium doped optical fiber amplifier (324). In step 420 the amplified optical return signal from the sensor array is converted to an electrical signal. This can be done using the optical receiver 326. At step 422 the electrical signals (representative of the data from the sensor array 100) are processed to extract the signals in the time domain. The can be done using the sampler 330. At step 424 the time domain data is processed to extract phase, sine and cosine information. This can be done using the demodulator 332. Also at this step the tangent information of the time domain data can be calculated. Then at step 426 the information (phase, sine, cosine, etc.) from the demodulator is filtered using a band pass filter (and/or other filters, such as a high-pass filter) to remove the bulk of the direct-component portion of the signals, thus leaving essentially only the dynamic alternating component portion of the signals. This filtering further assists in removing noise from outside of the seismic bandwidth (i.e., the portion of interest of the signals), and also removes data affected essentially by temperature changes. The signal filtering results in desirable seismic traces from the sensors (not numbered) in the sensor array. This seismic trace information is then cross correlated with the theoretical sweep of the source signals (311) to produce a data set representing signals from the Rayleigh vector sensors as affected by dynamic conditions within the borehole. Finally, at step 428 an output of amplitudes in the time domain of the data set generated in step 426 is generated. This output of amplitudes in the time domain can then be further processed using various seismic data processing methods. For example, the output of amplitudes in the time domain can be rotated so as to more easily visualize the amplitude imputed in each of the three orthogonal directions (A, R₁ and R₂).

It will be appreciated that the flowchart 400 is exemplary only, and that certain steps can be omitted, other steps added, and some steps performed in a different order. It will be further appreciated that the process 400 can be performed by apparatus other than that of the system 300. Further, while the flowchart 400 indicates specific components for performing certain of the steps, it will be appreciated that alternative components and/or circuitry which can perform the same or similar function can be used.

The Rayleigh vector sensor system provides at least the following advantages over prior art sensor systems.
Lower cost (estimated to be about $4,000 for each 3C level versus about $10,000 for each level of a fiber Bragg grating 3C system, and versus about $40,000 for each 3C level in a wireline based geophone system).
Higher operational temperature: can operate up to 300° C., whereas other sensors (e.g., geophones) are limited to about 200° C.
High sampling rate (i.e., high operational frequency). Can operate at an effective seismic bandwidth with a Nyquist frequency of about 4,000 Hz (i.e., 8,000 digital samples per second) versus an operational seismic bandwidth with a Nyquist frequency of frequency of about 250 Hz (i.e., 500 samples per second) for geophones. This allows for higher spatial sampling (i.e., ability to discern shorter distances in the formation being evaluated).
Higher sensitivity (signal amplitude): can sense signals that are 30-40 dB smaller than geophones. Can generate a strong signal over a large frequency range (e.g., between 0 Hz and 6,000 Hz a signal of between 9 db and −24 db between temperatures of 25° C. to 320° C.).
Ability to determine direction of signal (i.e., with an −80 dB cross-axial isolation of the three different signals) with a high level of precision.
Optical sensor (i.e., optical fiber based sensor) telemetry is inherently low noise since it does not pick up electrical noise from any source, as compared to geophone based systems which are prone to interference due to their electrical components and the wireline itself.
High signal-to-noise ratio (about 55 dB versus about 23 db for a geophone sensor; also, the Rayleigh vector sensor has a noise floor of about 50 ng/√Hz as compared to a noise floor of about 1000 ng/√Hz for geophones and MEMS sensors).
More channels can be placed on the sensor array (about 12,000 channels, or 4,000 3C levels, versus about 300 channels, or 100 3C levels, for geophones, allowing for (i) arrays of long length (e.g., about 10,000 m) and (ii) close spacing of the levels (10 m or less).
Optical sensors are inherently safe since they do not use electric power for either the sensor operation or the data transmission.

Performance Results of Rayleigh Vector Sensor and System

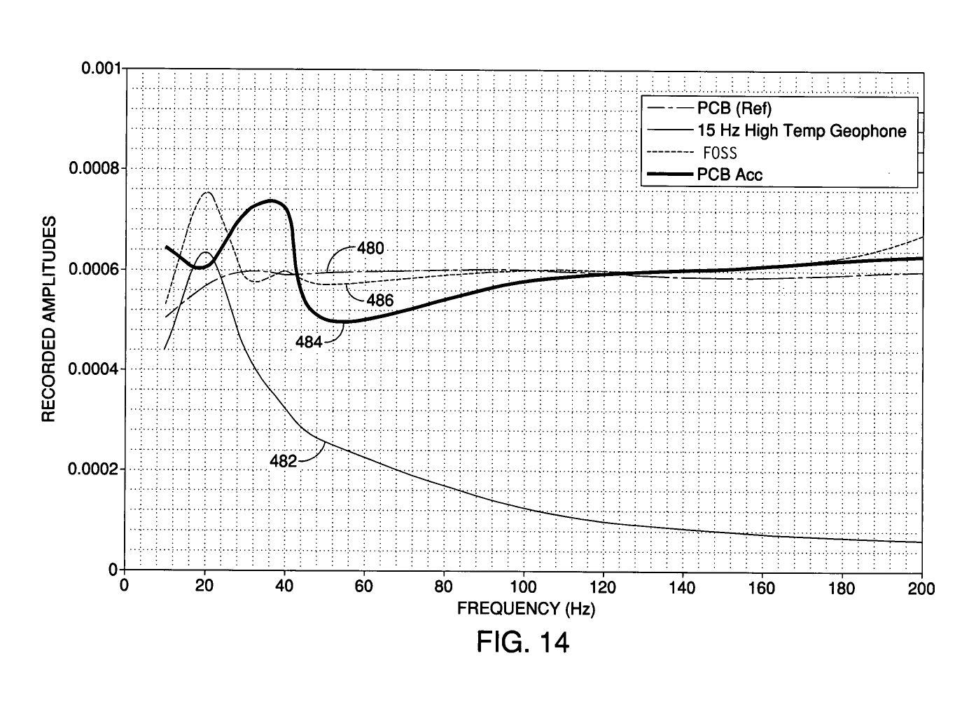

We tested the Rayleigh vector sensor using a dynamic test system which has a shaker head installed in an environmental chamber capable of extreme high and low temperatures. The results of these tests demonstrate that the Rayleigh vector sensor is superior to geophone sensors. More specifically, we tested the Rayleigh vector sensor at frequencies ranging from 0.01 Hz to 4,000 Hz, at temperatures ranging from 25° C. to 320° C. and at various accelerations. The first tests used a high frequency shaker system. We used sweeps from 5 Hz to 4,000 Hz at an acceleration of 600 μG to characterize the properties of the fiber optic seismic sensors. To compare and benchmark the Rayleigh vector sensor we performed simultaneous testing of the Rayleigh vector sensor against a standard 15 Hz coil geophone and two high performance piezoelectric accelerometers. We installed the four sensors on the shaker head inside an oven and attached the sensors to a data acquisition system which can simultaneously record all four sensors. We first tested the sensors at 25° C. in the frequency band 5 Hz to 4,000 Hz, followed by a 200° C. test using the same frequency band. The 10 Hz to 200 Hz, 600 μG test at 25° C. is shown in FIG. 14. Curve 480 of FIG. 14 (indicated as “PCB (Ref)”) is the output of a piezoelectric feedback accelerometer from 10 Hz to 200 Hz. This accelerometer feedback kept the shaker at 600 μG over the test frequency band of 5 Hz to 4,000 Hz, using a feedback loop system. Curve 482 is the amplitude output from the regular 15 Hz geophone from 10 Hz to 200 Hz. Curve 484 (indicated as “PCB Acc”) is from a second piezoelectric accelerometer. Curve 486 (indicated as “FOSS”—i.e., “Fiber Optic Seismic Sensor”) is the amplitude output of the fiber optic seismic sensor as a function of frequency for the Rayleigh vector sensor from 10 Hz to 200 Hz. The test results from the 200° C. tests are virtually identical to those at 25° C., demonstrating that the Rayleigh vector sensor is stable with temperature. Both the 25° C. and the 200° C. tests showed that the standard coil geophone lost most of its amplitude output at 100 Hz, while the Rayleigh vector sensor and the piezoelectric accelerometers retained the amplitude over the entire test frequency band of 5 Hz to 4,000 Hz.

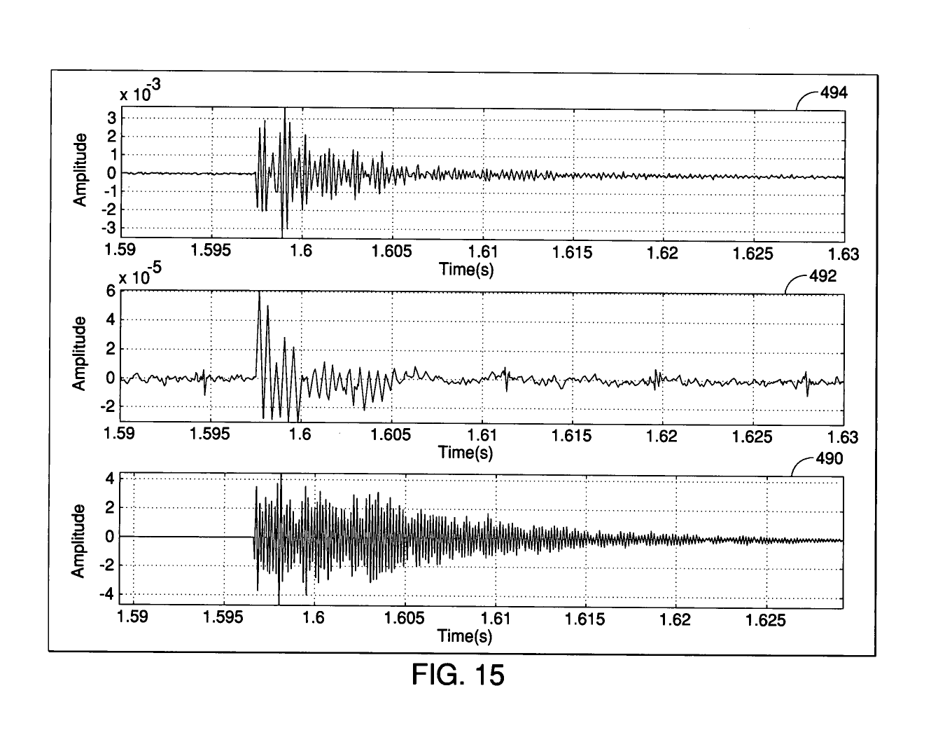

We next performed tap tests of the sensors (i.e., the Rayleigh vector sensor, a standard geophone sensor and a piezoelectric sensor). We placed the three sensors in close proximity to each other on the top of a granite block. To isolate the test system from environmental noise the granite block was placed on active vibration isolation pads. The first tap test was performed at an ambient temperature of about 25° C. The tests involved comparing the performance of the Rayleigh vector sensor (graph 490—FIG. 15) with a standard 15 Hz coil geophone (graph 492) and a high performance accelerometer (graph 494). The data from the simultaneous tap test of the three sensors is shown in FIG. 15. This figure shows that the first arrival of the Rayleigh vector sensor (bottom graph—490) has a faster rise time, indicating a higher frequency response, than the other sensors. It is also clear from this data that the Rayleigh vector sensor (bottom graph) has the highest signal/noise ratio. We calculated the signal-to-noise ratio by dividing the amplitude of the second positive peak with the mean amplitude of the pre-arrival data over a 5 ms window. The signal/noise ratio for the fiber optic seismic vector sensor was determined to be 617 (55 dB), the signal/noise ratio for the reference accelerometer was 149 (43 dB), and the signal-to-noise ratio for the 15 Hz geophone was 15 (23 dB) for this particular test. The fiber optic Rayleigh seismic vector sensor thus had a 41 times larger signal-to-noise ratio than the standard coil geophone, and a four times larger ratio than the piezoelectric accelerometer.

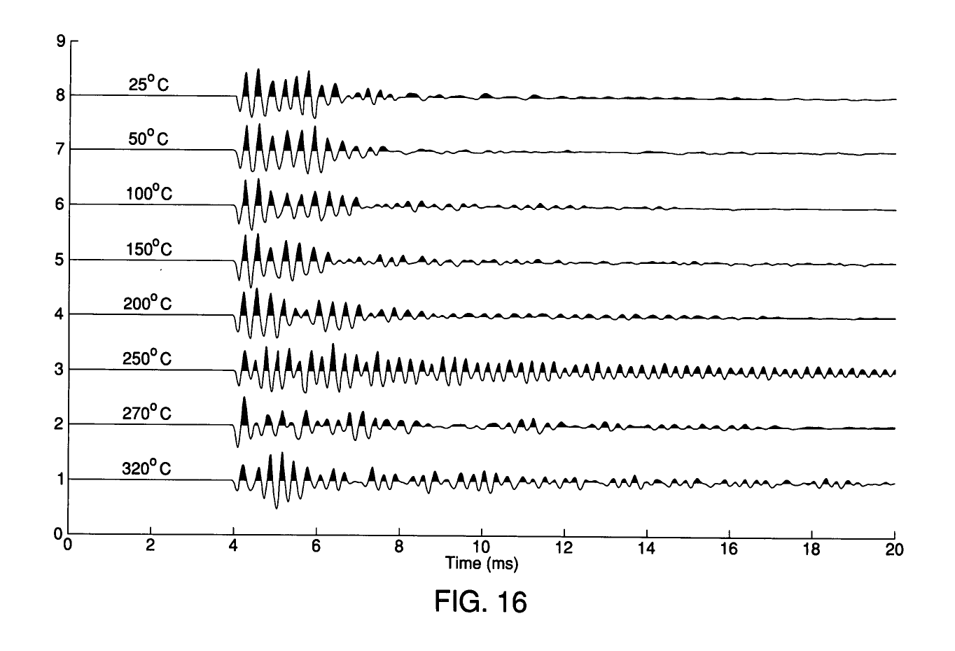

In FIG. 16 we show 20 ms records from eight different tap tests of a Rayleigh vector sensor at eight different temperatures ranging from 25° C. to 320° C. No filtering was applied so the data contained energy from below 5 Hz to 6,000 Hz. The results demonstrate that good amplitude data (and thus, a strong signal, and consequently a high signal to noise ratio) is received over the entire temperature range.

The preceding description has been presented only to illustrate and describe exemplary methods and apparatus of the present invention. It is not intended to be exhaustive or to limit the disclosure to any precise form disclosed. Many modifications and variations are possible in light of the above teaching.

We claim:

1. A vector sensor system comprising:
a sensor array comprising a plurality of sensor levels;
a plurality of optical fiber vector sensors, each sensor level having at least one of the optical fiber vector sensors;
an optical fiber;
circuitry configured to provide optical input signals into the optical fiber and to receive optical output signals from the optical fiber; and
wherein:
each optical fiber vector sensor comprises a vector mandrel and a first length of the optical fiber wound around the mandrel;
the sensor levels are connected to one another by a second length of the optical fiber; and
the circuitry is further configured to extract from the optical return signals backscattered light information from the first lengths of the optical fiber wound around the vector mandrels, and to determine phase change information between the optical input signals and the optical output signals based on the backscattered light information.

2. The vector sensor system of claim 1 and wherein the circuitry is further configured to determine amplitude information from the backscattered light information from the first lengths of the optical fiber wound around the vector mandrels.

3. The vector sensor system of claim 1 and wherein the backscattered light information is derived from Rayleigh backscattering signals generated within the first lengths of the optical fiber wound around the vector mandrels.

4. The vector sensor system of claim 1 and wherein the optical input signals are provided in dual-pulse pairs comprising a first input pulse and a second input pulse, and wherein the circuitry is configured to impart a phase modulation between the first and second input pulses.

5. The vector sensor system of claim 1 and wherein the vector mandrels comprise a first mandrel part, a second mandrel part, and a mandrel spring placed between the first and second mandrel parts.

6. The vector sensor system of claim 1 and wherein:
each vector mandrel is defined by a optical fiber winding axis about which the first lengths of the optical fiber are wound;
each sensor level comprises three optical fiber vector sensors supported by a sensor pod; and
the three optical fiber vector sensors supported by each sensor pod are supported in such a manner that the optical fiber winding axes of the three associated vector mandrels are orthogonal to one another.

7. The vector sensor system of claim 1 and wherein the circuitry includes an optical receiver configured to convert the optical return signals, including the backscattered light information, into electrical signals, and a sampler to extract the electrical signals in a time domain format.

8. The vector sensor system of claim 7 and wherein the circuitry includes a demodulator to extract phase, sine and cosine information from the electrical signals.

9. An optical fiber vector sensor comprising:
a vector mandrel having a first mandrel part and a second mandrel part, the first and second mandrel parts being spaced-apart from one another by a mandrel gap;
a mandrel spring placed in the mandrel gap and being in contact with the first and second mandrel parts; and
an optical fiber wound around the first and second mandrel parts to generate a plurality of optical fiber windings which span the mandrel gap.

10. The optical fiber vector sensor of claim 9 and wherein the first and second mandrel parts define generally parallel opposing planar surfaces at the mandrel gap, and the mandrel spring is configured to allow relative motion of the first and second mandrel parts in a direction perpendicular to the opposing planar surfaces, while restricting movement in directions parallel to the opposing planar surfaces.

11. The optical fiber sensor of claim 10 and wherein the first and second mandrel parts, and the mandrel spring, are integrated components.

12. The optical fiber vector sensor of claim 9 and further comprising a torsional restricting member placed within the mandrel gap and configured to resist rotational movement of the first and second mandrel parts with respect to one another.

13. The optical fiber vector sensor of claim 9 and wherein the mandrel spring comprises a torsional restricting member configured to resist rotational movement of the first and second mandrel parts with respect to one another.

14. The optical fiber vector sensor of claim 9 and wherein:
the mandrel spring comprises a plate spring disposed within the mandrel gap between the first and second mandrel parts, the mandrel spring being defined by a mandrel spring upper surface and an mandrel spring lower surface, and further defined by opposing mandrel spring ends and mandrel spring sides, the first mandrel part being defined by a first mandrel part inner surface, and the second mandrel part being defined by a second mandrel part inner surface, the first and second mandrel part inner surfaces being generally parallel to one another and spaced-apart by the mandrel gap; and
the vector mandrel further comprises:
first and second upper spring connecting members attached to the opposing ends of the mandrel spring upper surface and also attached to the first mandrel part inner surface; and
first and second lower spring connecting members attached to the opposing sides of the mandrel spring lower surface and also attached to the second mandrel part inner surface; and
wherein the opposing ends and opposing sides of the mandrel spring are oriented generally orthogonal to one another.

15. The optical fiber vector sensor of claim 9 and wherein, in a cross section parallel to the optical fiber windings, the vector mandrel is essentially rectangular in shape with rounded corners at intersecting sides of the essentially rectangular shape.

16. The optical fiber vector sensor of claim 15 and wherein the rounded corners are defined by a rounded corner radius of between about 0.1 inches and 0.4 inches.

17. The optical fiber vector sensor of claim 9 and wherein:
the mandrel is defined by a mandrel length which is perpendicular to the optical fiber windings, and the mandrel length is between about 0.2 inches and 2.0 inches;
the mandrel is defined by a mandrel width which is perpendicular to the optical fiber windings, and the mandrel width is between about 0.2 inches and 2.0 inches;
the mandrel is defined by a mandrel height which is parallel to the optical fiber windings, and the mandrel height is between about 0.2 inches and 2.0 inches; and
the mandrel gap is between about 0.05 inches and 0.5 inches.

18. The optical fiber vector sensor of claim 17 and wherein, in a cross section parallel to the optical fiber windings, the vector mandrel is essentially rectangular in shape with rounded corners at intersecting sides of the essentially rectangular shape, and the rounded corners are defined by a rounded corner radius of between about 0.1 inches and 0.4 inches.

19. The optical fiber vector sensor of claim 9 and wherein the second mandrel part comprises a slug of a metal having a density of between about 15 and 25 grams per cubic centimeter.

20. The optical fiber vector sensor of claim 9 and wherein the optical fiber windings are defined by a length of optical fiber of between about 2 meters and 25 meters.

21. The optical fiber vector sensor of claim 9 and wherein the optical fiber does not have a fiber Bragg grating formed therein.

22. The optical fiber vector sensor of claim 9 and wherein the mandrel spring is in a state of compression to preload the optical fiber windings.

23. An optical fiber vector sensor array comprising:
a plurality of sensor housings, each sensor housing supporting a sensor pod, each sensor pod defining a sensor level;
a plurality of optical fiber vector sensors supported by each sensor pod;
a plurality of sensor pod connectors separating the sensor pods in spaced-apart relation to one another;
a sensor pod clamping system for securing the sensor pods into contact with a borehole wall;
an optical fiber; and wherein:
each optical fiber vector sensor comprises a vector mandrel having a first mandrel part and a second mandrel part, the first and second mandrel parts being spaced-apart from one another by a mandrel gap;
a mandrel spring placed in the mandrel gap and being in contact with the first and second mandrel parts;
a first length of the optical fiber is wound around the first and second mandrel parts to generate a plurality of optical fiber windings which span the mandrel gap; and
a second length of the optical fiber is disposed between each sensor pod.

24. The optical fiber vector sensor array of claim 23 and wherein the sensor pod connectors comprise hydraulic tubing conveying a hydraulic fluid, and the hydraulic fluid is used to actuate the sensor pod clamping system.

25. The optical fiber vector sensor array of claim 23 and wherein:
each vector mandrel is defined by a optical fiber winding axis about which the first lengths of the optical fiber are wound;
each sensor pod supports three of the optical fiber vector sensors; and
the three optical fiber vector sensors supported by each sensor pod are supported in such a manner that the optical fiber winding axes of the three associated vector mandrels are orthogonal to one another.

26. A method comprising:
providing an optical fiber;
providing an optical fiber vector sensor comprising a vector mandrel having a plurality of windings of the optical fiber about the mandrel to produce an optical fiber point sensor;
providing an optical input signal to the optical fiber such that the optical input signal is provided to the optical fiber point sensor;
receiving an optical return signal from the optical fiber based on the optical input signal which was provided to the optical fiber point sensor;
extracting from the optical return signal backscattered light information from the windings of the optical fiber wound around the mandrel;
extracting from the backscattered light information output signals in a time domain;
determining phase change information between the optical input signal and the optical output signals based on the backscattered light information contained within the output signals in the time domain;
extracting from the backscattered light information amplitude information; and
generating an output of amplitudes in the time domain representing events detected by the optical fiber sensor based on the backscattered light information generated by the optical fiber sensor.
